(19) United States
(12) Patent Application Publication
(10) Pub. No.: US 2026/0300895 A1
(43) Pub. Date: Oct. 1, 2026

(54) APPARATUS, SYSTEM, AND METHOD OF SHIPMENT VETTING BASED ON A DECLARED DESCRIPTION OF GOODS

(71) Applicant: Ultra Information Solutions Ltd., Herzliya (IL)

(72) Inventors: Ben Gold, Tel Aviv-Yafo (IL); Ori Ben Yehuda, Tel Aviv-Yafo (IL)

(73) Assignee: Ultra Information Solutions Ltd., Herzliya (IL)

(21) Appl. No.: 19/090,473

(22) Filed: Mar. 26, 2025

(51) Int. Cl. G06Q 10/0831; G06Q 10/0635

(52) U.S. Cl. CPC G06Q 10/0831; G06Q 10/0635

(57) ABSTRACT

Some demonstrative aspects include apparatuses, systems and/or methods of shipment vetting. For example, a computing system may process declared goods information corresponding to goods of an imported shipment to identify a declared description of the goods and a declared Harmonic System (HS) code for the goods; to determine a predicted HS code based on the declared description of the goods; to determine risk information to indicate one or more risks corresponding to a declaration fraud based on a mismatch between the declared HS code and the predicted HS code; and to provide an output including vetting information. For example, the vetting information may include the risk information and the predicted HS code.

### BACKGROUND

Custom authorities control a flow of goods into and out of countries.

There is a need to provide a technical solution to support the relatively complex and time consuming process of custom authorities to vet imports, for example, to collect taxes, to ensure safety, security, and/or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow chart illustration of a method of determining shipment vetting information for goods of an imported shipment, in accordance with some demonstrative aspects.

FIGS. 3A and 3B are schematic flow chart illustrations of a method of determining shipment vetting information based on first declared goods information, in accordance with some demonstrative aspects.

FIG. 4A and FIG. 4B are schematic flow chart illustrations of a method of determining shipment vetting information based on second declared goods information, in accordance with some demonstrative aspects.

FIGS. 5A and 5B are schematic flow chart illustrations of a method of determining shipment vetting information based on third declared goods information, in accordance with some demonstrative aspects.

FIGS. 6A and 6B are schematic flow chart illustrations of a method of determining risk information for goods of an imported shipment based on declared goods information, in accordance with some demonstrative aspects.

FIGS. 7A and 7B are schematic flow chart illustrations of a method of determining one or more classification codes for goods of an imported shipment, in accordance with some demonstrative aspects.

FIG. 8 is a schematic flow chart illustration of a method of providing shipment vetting information, in accordance with some demonstrative aspects.

FIG. 9 is a schematic flow chart illustration of a method of presenting shipment vetting information to a user, in accordance with some demonstrative aspects.

FIG. 10 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by, or in connection with, a computer or any instruction execution system. For example, a computer-usable or computer-readable medium may be or may include any apparatus that can contain, store, communicate, propagate, and/or transport the program for use by or in connection with the instruction execution system, apparatus, and/or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled, directly or indirectly, to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may include one or more wired or wireless links, may utilize one or more components of wireless communication, may utilize one or more methods or protocols of wireless communication, or the like. Some aspects may utilize wired communication and/or wireless communication.

Some aspects may be used in conjunction with various devices and systems, for example, a computing device, a mobile device, portable device, a Smartphone, a Personal Computer (PC), a desktop computer, a server computer, a cloud server, a web-based server, a mobile computer, a laptop computer, a notebook computer, a mobile phone, a tablet computer, a handheld computer, a handheld device, a mobile or portable device, a non-mobile or non-portable device, a cellular telephone, a wireless telephone, a device having one or more internal antennas and/or external antennas, a wireless handheld device, or the like.

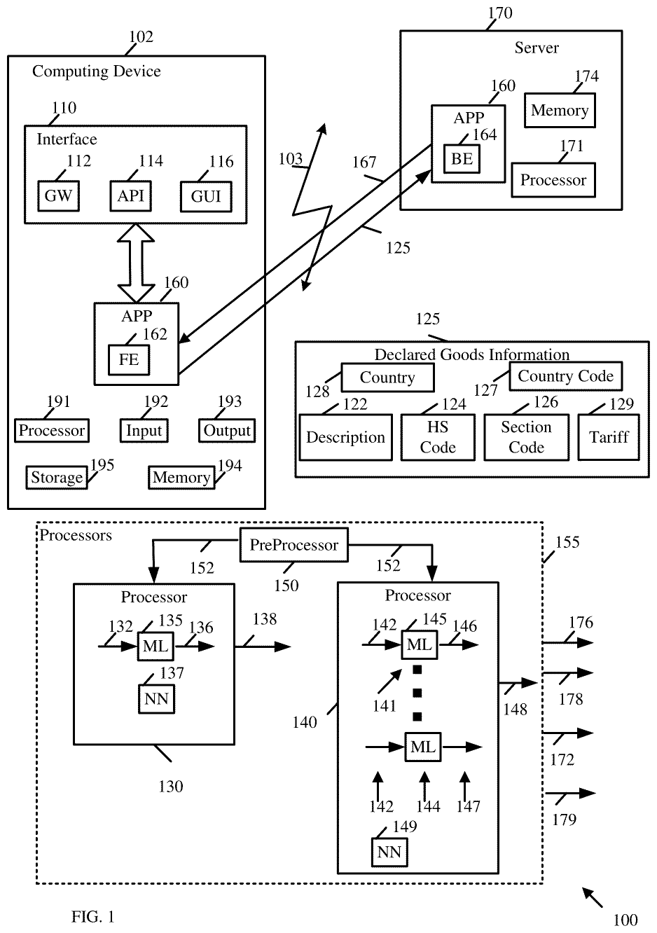

Reference is now made to FIG. 1, which schematically illustrates a block diagram of a system 100, in accordance with some demonstrative aspects.

As shown in FIG. 1, in some demonstrative aspects, system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computing device, a mobile device, a Smartphone, a Personal Computer (PC), a desktop computer, a mobile computer, a laptop computer, a notebook computer, a Cellular phone, a notebook, a tablet computer, a handheld computer, a handheld device, a wireless communication device, or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multipurpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a Light Emitting Diode (LED) display unit, a flat panel display, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via a wireless and/or wired network 103.

In some demonstrative aspects, network 103 may include a wired network, a local area network (LAN), a wireless LAN (WLAN) network, a radio network, a cellular network, a Wi-Fi network, a Bluetooth (BT) network, and the like.

In some demonstrative aspects, device 102 may be configured to perform and/or to execute one or more operations, modules, processes, procedures, and/or the like.

In some demonstrative aspects, system 100 may include an application 160, which may be implemented by, as part of, and/or in the form of, at least one service, module, and/or controller, e.g., as described below.

In some demonstrative aspects, application 160 may include, or may be implemented as, software, a software module, an application, a program, a subroutine, instructions, an instruction set, computing code, words, values, symbols, and/or the like.

In some demonstrative aspects, application 160 may include a front-end 162 to be executed by device 102, e.g., as described below.

In some demonstrative aspects, memory unit 194 and/or storage unit 195 may store instructions resulting in front-end 162, and/or processor 191 may be configured to execute the instructions resulting in front-end 162 and/or to perform one or more calculations and/or processes of front-end 162, e.g., as described below.

In other aspects, application 160 may include a back-end 164 to be executed by a suitable computing system, e.g., a server 170.

In some demonstrative aspects, server 170 may include at least one of a remote server, a web-based server, a cloud server, and/or any other server.

In some demonstrative aspects, device 102 may communicate with server 170, for example, via network 103.

In some demonstrative aspects, the server 170 may include a suitable memory and/or storage unit 174 having stored thereon instructions resulting in back-end 164 of application 160, and a suitable processor 171 to execute the instructions, e.g., as described below.

In some demonstrative aspects, application 160 may include a combination of back-end 164 and front-end 162.

In some demonstrative aspects, application 160 may be downloaded and/or received by the user of device 102 from another computing system, e.g., server 170, such that front-end 162 may be executed locally by users of device 102. For example, some or all of the instructions of application 160 may be received and stored, e.g., temporarily, in a memory or any suitable short-term memory or buffer of device 102, e.g., prior to being executed by processor 191 of device 102.

In some demonstrative aspects, front-end 162 may be executed locally by device 102, and backend 164 may be executed by server 170.

In some demonstrative aspects, the front-end 162 may include and/or may be implemented as a local application, a web application, a web site, a web client, e.g., a Hypertext Markup Language (HTML) web application, or the like.

In some demonstrative aspects, the back-end 164 may include and/or may be implemented as a remote application, a web server, a Software as a Service (SAS), a cloud service, or the like.

For example, one or more first operations of application 160 may be performed locally, for example, by front-end 162 in device 102, and/or one or more second operations of application 160 may be performed remotely, for example, by back-end 164 in server 170, e.g., as described below.

In other aspects, application 160 may include and/or may be implemented by any other suitable computing arrangement and/or scheme.

In some demonstrative aspects, device 102 may be configured to allow one or more users to interact with one or more processes, applications and/or modules of device 102, e.g., as described herein.

In some demonstrative aspects, system 100 may include an interface 110 to interface between a user of device 102 and one or more elements of system 100, e.g., application 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of application 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component (e.g., a Flash or Shockwave component), or the like.

In some demonstrative aspects, interface 110 may be associated with and/or may include, for example, a gateway (GW) 112 and/or an application programming interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, application 160 may be configured to perform one or more operations, functionalities, and/or communications of shipment inspection recommendation, shipment vetting, and/or shipment analysis, e.g., as described below.

In some demonstrative aspects, application 160 may be configured to perform the one or more operations, functionalities, and/or communications of shipment inspection recommendation, shipment vetting, and/or shipment analysis, for example, for a plurality of shipments, for example, imported shipments, e.g., as described below.

Some demonstrative aspects are described herein with respect to shipment inspection recommendation, shipment vetting, and/or shipment analysis corresponding to imported shipments. In other aspects, one or more of the operations and/or functionalities of shipment inspection recommendation, shipment vetting, and/or shipment analysis, e.g., as described herein, may be performed with respect to exported shipments.

In some demonstrative aspects, an imported shipment may include one or more goods, which may be imported from an origin country into a destination country, for example, by an importer, e.g., as described below.

In some demonstrative aspects, the one or more goods may be imported via a port of loading, e.g., in the country of origin, and a port of discharging, e.g., in the country of destination, e.g., as described below.

In some demonstrative aspects, the one or more goods may be carried by a vessel, which may travel between the port of loading and the port of discharging, e.g., as described below.

In some demonstrative aspects, the vessel may include one or more containers to contain the one or more goods of the imported shipment, e.g., as described below.

In some demonstrative aspects, customs and/or tax authorities of a destination country may vet and/or analyze the imported shipment, for example, to collect revenues for the destination country.

In one example, the revenues may include, for example, import customs, duty taxes, import taxes, and/or the like.

In some demonstrative aspects, the customs and/or tax authorities may vet and/or analyze the imported shipment, for example, to ensure correct tariff, import customs, duty taxes, import taxes, and/or the like.

In some demonstrative aspects, the customs and/or tax authorities may vet and/or analyze the imported shipment, for example, to ensure security of the destination country.

In one example, the customs and/or tax authorities may vet and/or analyze the imported shipment, for example, to ensure the goods are not prohibited from being imported into the destination country.

In some demonstrative aspects, the customs and/or tax authorities may vet and/or analyze the imported shipment, for example, to ensure safety of the goods.

In some demonstrative aspects, the customs and/or tax authorities may vet and/or analyze the imported shipment for any other additional or alternative purpose.

In some demonstrative aspects, application 160 may be configured to provide a technical solution to support automatic inspection, vetting and/or analysis of a plurality of shipments, for example, the plurality of imported shipments, e.g., as described below.

In some demonstrative aspects, application 160 may be configured to automatically vet, inspect and/or analyze an imported shipment, for example, based on vetting, inspection, and/or analysis of information corresponding to the one or more goods of the imported shipment, e.g., as described below.

In some demonstrative aspects, the one or more goods of the imported shipment may include, for example, a same type of goods, e.g., a specific material.

In some demonstrative aspects, the one or more goods of the imported shipment may include, for example, different types of goods, e.g., different types of chairs.

In some demonstrative aspects, the one or more goods of the imported shipment may include, for example, one or more materials, chemicals, households goods, vehicles, electric devices, electronic devices, and/or the like.

In some demonstrative aspects, the imported shipment may be associated with shipment documentation, e.g., as described below.

In some demonstrative aspects, the shipment documentation may include a Bill of Lading (BOL), e.g., as described below.

In some demonstrative aspects, the shipment documentation may include any other additional and/or alternative documentation.

In some demonstrative aspects, the shipment documentation may be received by the customs authority of the destination country.

In some demonstrative aspects, the shipment documentation may be submitted to the customs authority of the destination country, for example, by one or more shipment-related entities.

In one example, the shipment documentation may be submitted to the customs authority, for example, by an importer of the imported shipment, a broker of the imported shipment, and/or any other entity.

In some demonstrative aspects, application 160 may be configured to automatically vet, inspect and/or analyze an imported shipment, for example, based on vetting, inspection, and/or analysis of the shipment documentation of the imported shipment, e.g., as described below.

In some demonstrative aspects, application 160 may be configured to automatically vet, inspect and/or analyze an imported shipment, for example, based on vetting, inspection, and/or analysis of shipment information in a BOL and/or a declaration of the imported shipment, e.g., as described below.

In some demonstrative aspects, the shipment documentation may include declared goods information 125 corresponding to goods of the imported shipment, e.g., as described below.

In some demonstrative aspects, application 160 may be configured to automatically vet, inspect and/or analyze an imported shipment, for example, based on vetting, inspection, and/or analysis of the declared goods information 125 corresponding to the imported shipment, e.g., as described below.

In some demonstrative aspects, the declared goods information 125 may include a declared description 122 of the goods, e.g., as described below.

In some demonstrative aspects, application 160 may be configured to automatically vet, inspect and/or analyze the imported shipment, for example, based on vetting, inspection, and/or analysis of the declared description 122 of the goods corresponding to the imported shipment, e.g., as described below.

In some demonstrative aspects, the declared description 122 of the goods may include one or more words to describe the goods of the imported shipment.

In one example, the declared description of the goods may include between 7-15 words, or any other suitable number of words, to describe the goods of the imported shipment.

In some demonstrative aspects, the declared goods information 125 for the goods may include, for example, classification information of the goods, e.g., as described below.

In some demonstrative aspects, application 160 may be configured to automatically vet, inspect and/or analyze an imported shipment, for example, based on vetting, inspection, and/or analysis of the classification information of the goods, e.g., as described below.

In some demonstrative aspects, the classification information may include, for example, a classification of the goods, for example, according to a Harmonized System (HS).

In some demonstrative aspects, the classification information may include, for example, a classification of the goods, for example, according to Harmonized System (HS) codes of the Harmonized System.

In one example, the HS may be organized into a plurality of sections, e.g., 21 sections or any other number of sections. For example, the plurality of sections may describe broad categories of goods.

For example, a section of the plurality of sections may include a plurality of chapters, which may describe sub categories of the goods corresponding to the section. For example, the sub categories may be more specific than the section.

In some demonstrative aspects, an HS code may be configured to classify goods, for example, according to the harmonized system.

In some demonstrative aspects, an HS code may include a standard multipurpose international product description code created by the World Customs Organization (WCO). For example, the HS code may be used by customs departments throughout the world to identify types of goods that can be shipped.

For example, an HS code may be formatted according a predefined HS format, which may include, for example, a header and a sub-header. For example, the header may include one or more digits, e.g., 2-4 digits or any other number of digits, of the HS code. For example, the sub-header may include all other remaining digits of the HS code.

In some demonstrative aspects, the declared goods information 125 may include a declared HS-code 124 for the goods, e.g., as described below.

In some demonstrative aspects, application 160 may be configured to automatically vet, inspect and/or analyze the imported shipment, for example, based on vetting, inspection, and/or analysis of the declared HS-code 124 for the goods, e.g., as described below.

In some demonstrative aspects, application 160 may be configured to automatically vet, inspect and/or analyze the imported shipment, for example, based on a mismatch between the declared HS code 124 of the goods and the declared description 122 of the goods, e.g., as described below.

In some demonstrative aspects, application 160 may be configured to automatically determine the detected mismatch between the declared HS code 124 of the goods and the declared description 122 of the goods, for example, based on a mismatch between the declared HS code 124 and an HS code (“expected HS code”), which may be determined based on the declared description 122 of the goods, e.g., as described below.

In some demonstrative aspects, application 160 may be configured to automatically determine the expected HS code to include an HS code, which may correspond to, match, and/or be correlated to, the declared description 122 of the goods.

In some demonstrative aspects, a classification of the goods according to the declared HS code 124 may affect, for example, a tariff for the goods.

In one example, a first HS code may correspond to a first tariff to be applied to the goods, and a second HS code may correspond to a second tariff, which may be higher than the first tariff, to be applied to the goods.

In some demonstrative aspects, classification of the goods according to the declared HS code 124 may affect, for example, safety regulations for the goods.

In one example, a first HS code may correspond to first safety regulations to be applied to the goods, and a second HS code may correspond to second safety regulations to be applied to the goods, which may be different from the first safety regulations. For example, the second safety regulations may be more complicated, costly, time consuming, and/or the like, for example, compared to the first safety regulations.

In some demonstrative aspects, classification of the goods according to the declared HS code 124 may affect, for example, one or more import procedures, which may be utilized to import the goods.

In one example, a first HS code may correspond to first import procedures to be applied to the goods, and a second HS code may correspond to second import procedures, which may be different from the first import procedures, to be applied to the goods. For example, the second import procedures may be more complicated, costly, time consuming, and/or the like, for example, compared to the first import procedures.

In some demonstrative aspects, application 160 may be configured to implement one or more operations and/or functionalities of a shipment vetting mechanism, which may be configured to detect the mismatch between the declared HS code 124 of the goods and the declared description 122, for example, to provide a technical solution to avoid situations, where a wrong declared HS code 124 may affect the tariff to be applied with respect to the goods, the safety regulations to be applied with respect to the goods, the import procedures to be applied with respect to the goods, and/or any other additional and/or alternative factors, which may be applied with respect to the goods based on the declared HS code 124.

In one example, a wrong HS code 124 may be declared, e.g., by an importer of the goods, for example, in attempt to reduce or even avoid payment of customs for the goods, in attempt to avoid one or more safety regulations, and/or in attempt to avoid one or more import procedures.

In some demonstrative aspects, the declared goods information 125 may include a declared section code 126 for the goods.

In some demonstrative aspects, application 160 may be configured to automatically vet, inspect and/or analyze the imported shipment, for example, based on vetting, inspection, and/or analysis of the declared section code 126 for the goods, e.g., as described below.

In some demonstrative aspects, application 160 may be configured to automatically vet, inspect and/or analyze the imported shipment, for example, based on a mismatch between the declared section code 126 of the goods and the declared description 122 of the goods, e.g., as described below.

In some demonstrative aspects, application 160 may be configured to automatically determine the detected mismatch between the declared section code 126 of the goods and the declared description 122 of the goods, for example, based on a mismatch between the declared section code 126 and a section code (“expected section code”), which may be determined based on the declared description 122 of the goods, e.g., as described below.

In some demonstrative aspects, application 160 may be configured to automatically determine the expected section code to include a section code, which may correspond to, match, and/or be correlated to, the declared description 122 of the goods.

In some demonstrative aspects, application 160 may be configured to implement one or more operations and/or functionalities of a shipment vetting mechanism, which may be configured to detect the mismatch between the declared section code 126 of the goods and the declared description 122, for example, to provide a technical solution to avoid situations, where a wrong declared section code 126 may affect the tariff to be applied with respect to the goods, the safety regulations to be applied with respect to the goods, the import procedures to be applied with respect to the goods, and/or any other additional and/or alternative factors, which may be applied with respect to the goods based on the declared section code 126.

In another example, application 160 may be configured to automatically vet, inspect and/or analyze an imported shipment, for example, based on a mismatch between any other additional or alternative declared information in the declared goods information 125 and the declared description 122 of the goods.

In another example, application 160 may be configured to automatically vet, inspect and/or analyze an imported shipment, for example, based on vetting, inspection, and/or analysis of any other additional or alternative information in the declared goods information.

In some demonstrative aspects, application 160 may be configured to provide a technical solution to support vetting of imported shipments, for example, for customs and/or tax authorities, and/or law enforcement personnel, e.g., as described below.

In some demonstrative aspects, application 160 may be configured to provide a technical solution to support empowering custom officials and/or analysts to vet imported shipments, for example, in order to collect revenue effectively, e.g., as described below.

In some demonstrative aspects, application 160 may be configured to provide a technical solution to facilitate trade and/or to ensure national security and/or safety, e.g., as described below.

In some demonstrative aspects, application 160 may be configured to provide a technical solution, which may support customs, tax authorities and/or law enforcement agencies across the globe to inspect almost all, e.g., substantially a hundred percent, of goods imported into a country, e.g., as described below.

In some demonstrative aspects, application 160 may be configured to receive and/or analyze the declared goods information 125 in the shipment documentation, for example, to detect and/or indicate suspicious and/or risky declarations for goods in imported shipments, e.g., as described below.

In some demonstrative aspects, application 160 may be configured to present to a user conclusions, e.g., vetting recommendations, for example, with respect to the declared goods information 125 of an imported shipment, e.g., even for each imported shipment, for example, using a user interface, e.g., a web interface or any other interface, for example, by indicating the suspicious and/or risky declarations for goods of imported shipments, e.g., as described below.

In some demonstrative aspects, application 160 may be configured to screen a large amount e.g., substantially 100%, of shipments imported into a country, for example, to classify goods of a shipment, e.g., as cleared goods, or as suspicious goods, e.g., as described below.

In some demonstrative aspects, application 160 may be configured to detect and/or predict fraud patterns with respect to the goods of the imported shipment, e.g., as described below.

In some demonstrative aspects, application 160 may be configured to detect and/or predict a declaration fraud with respect to the declared goods information 125 of the goods, e.g., as described below.

In some demonstrative aspects, application 160 may be configured to identify a declaration fraud, for example, based on analysis of raw data in the declared goods information 125, e.g., as described below.

In some demonstrative aspects, application 160 may be configured to provide an import inspection recommendation corresponding to an imported shipment, for example, based on analysis of the declared goods information 125 corresponding to one or more goods in the imported shipment, e.g., as described below.

In some demonstrative aspects, the import inspection recommendation may include a clear recommendation, an inspect recommendation, or a caution recommendation, e.g., as described below. In other aspects, any other additional or alternative inspection recommendation may be implemented.

In some demonstrative aspects, the clear recommendation may indicate that no indicative flags, e.g., declaration fraud risks, are related to the imported shipment.

In some demonstrative aspects, the caution recommendation may indicate that there may be some issues with the imported shipment, e.g., possible declaration fraud risks, which may require the attention of a user, e.g., a customs officer, e.g., as described below.

In one example, a decision of whether to inspect the imported shipment may be up to the user, e.g., the customs officer.

In some demonstrative aspects, the inspect recommendation may indicate that there may be flags, e.g., declaration fraud risks, pertaining the imported shipment, which may raise a necessity of inspection of the imported shipment, e.g., as described below.

In other aspects, the import inspection recommendation may include any other additional and/or alternative recommendation.

In some demonstrative aspects, application 160 may be configured to provide a conclusion reasoning for the inspect recommendation, and/or for the caution recommendation, e.g., as described below.

In some demonstrative aspects, application 160 may include and/or may perform the functionality of a shipment analyzer, which may be configured to analyze declared information relating to the declared HS code 124, and/or the declared section code 126 in the declared goods information 125 of the imported shipment, e.g., as described below.

In some demonstrative aspects, application 160 may include and/or may perform the functionality of a shipment analyzer, which may be configured to detect a risk of fraud with respect to the declared information, for example, based on the analysis of the declared information, e.g., as described below.

In some demonstrative aspects, application 160 may be configured to perform one or more operations, functionalities, and/or communications of imported shipment vetting of a plurality of imported shipments, for example, for customs authorities, e.g., as described below.

Some demonstrative aspects are described herein with respect to a shipment analyzer, e.g., application 160, which may be configured to perform imported shipment vetting of a plurality of imported shipments.

In other aspects, the shipment analyzer, e.g., application 160, may be configured to perform one or more operations of any other additional or alternative shipment vetting, e.g., with respect to exported shipments.

In some demonstrative aspects, application 160 may be configured to provide a technical solution to support imported shipment vetting, for example, for customs authorities. For example, application 160 may be configured to support the customs authorities to vet and/or analyze a plurality of imported shipments to be inspected by the customs authorities, e.g., as described below.

In some demonstrative aspects, application 160 may be configured to provide a technical solution to support imported shipment vetting of a plurality of imported shipments, for example, a relatively large number of imported shipments, e.g., as described below.

In some demonstrative aspects, one or more, e.g., some or all, operations and/or functionalities, of application 160 may be executed by one or more processors 155, e.g., as described below.

In some demonstrative aspects, one or more memories, e.g., one or more memories 174 and/or one or more memories 194, may be configured to store suitable instructions, which when executed by the one or more processors 155, result in execution of one or more, e.g., some or all, operations and/or functionalities, of application 160, e.g., as described below.

In some demonstrative aspects, the one or more processors 155 may be implemented using any suitable hardware components and/or software components, for example, processors, controllers, memory units, storage units, input units, output units, communication units, operating systems, and/or applications.

In some aspects, the one or more processors 155 may be implemented as part of any suitable module, system, device, or component of system 100.

In other aspects, one or more processors 155 may be implemented as a separate element of system 100.

In some demonstrative aspects, the one or more processors 155 may be implemented as part of server 170. For example, the one or more processors 155 may be associated with and/or included as part of server 170.

For example, the one or more processors 155 may be implemented as part of processor 171 or any other element of server 170.

In some demonstrative aspects, the one or more processors 155 may be implemented as a separate element of server 170.

In some demonstrative aspects, the one or more processors 155 may be implemented as part of device 102. For example, the one or more processors 155 may be implemented, associated with and/or included as part of device 102.

For example, the one or more processors 155 may be implemented, for example, as part of processor 191 and/or as part of an OS of device 102.

In some demonstrative aspects, the one or more processors 155 may be implemented as a separate element of device 102.

In some demonstrative aspects, one or more first processors, e.g., some or all of the one or more processors 155 may be implemented by device 170; and/or one or more second processors, e.g., some or all, of the one or more processors 155 may be implemented by device 102.

In some demonstrative aspects, application 160, e.g., back-end 164, may be configured to process declared goods information 125 corresponding to goods of an imported shipment, e.g., as described below.

In some demonstrative aspects, application 160, e.g., front end-end 162, may be configured to send to server 170 the declared goods information 125 corresponding to the goods of the imported shipment, e.g., as described below.

In some demonstrative aspects, the declared goods information 125 may include the declared description 122 of the goods, e.g., as described below.

In some demonstrative aspects, the declared goods information 125 may include the declared HS code 124 for the goods, e.g., as described below.

In some demonstrative aspects, application 160, e.g., back-end 164, may be configured to process the declared goods information 125 corresponding to the goods of the imported shipment, for example, to identify the declared description 122 of the goods and the declared HS code 124 for the goods, e.g., as described below.

In some demonstrative aspects, application 160, e.g., back-end 164, may be configured to determine a predicted HS code 178, for example, based on the declared description 122 of the goods, e.g., as described below.

In some demonstrative aspects, application 160, e.g., back-end 164, may be configured to determine the risk information 172 to indicate one or more risks corresponding to a declaration fraud, for example, based on a mismatch between the declared HS code 124 and the predicted HS code 178, e.g., as described below.

In some demonstrative aspects, application 160, e.g., back-end 164, may be configured to provide an output including vetting information 167, e.g., as described below.

In some demonstrative aspects, application 160 may be configured to utilize a suitable output, for example, an output interface, output unit, output module, output component, output circuitry, memory interface, memory access unit, memory writer, digital memory unit, bus interface, processor interface, or the like, which may be capable of outputting the vetting information 167, for example, to a local memory, a processor, and/or any other suitable component to handle the vetting information 167.

In some demonstrative aspects, the vetting information 167 may include the risk information 172 and the predicted HS code 178, e.g., as described below.

In some demonstrative aspects, application 160, e.g., back-end 164, may be configured to determine a first predicted HS code 178, for example, based on a first declared description 122 of the goods, e.g., as described below.

In some demonstrative aspects, application 160, e.g., back-end 164, may be configured to determine a second predicted HS code 178, for example, based on a second declared description 122 of the goods, e.g., as described below.

In some demonstrative aspects, the second predicted HS code 178 may be different from the first predicted HS code 178, e.g., as described below.

In some demonstrative aspects, the second declared description 122 may be different from the first declared description 122, e.g., as described below.

In some demonstrative aspects, the declared goods information 125 may include a declared section code 126 for the goods, e.g., as described below.

In some demonstrative aspects, the declared goods information 125 may include country-of-origin information 128 corresponding to a country of origin, e.g., an exporter country, of the imported shipment, e.g., as described below.

In some demonstrative aspects, the declared goods information 125 may include tariff information 129 corresponding to a declared tariff for the goods, e.g., as described below.

In some demonstrative aspects, the declared goods information 125 may include a country code 127, e.g., a tariff country code, corresponding to a country code of the exporter country or an importer country of the goods, e.g., as described below.

In one example, country code 127 may include a tariff country International Organization for Standardization (ISO) code. In other aspects, any other country code information may be used.

In other aspects, the declared goods information 125 may include any other additional and/or alternative information.

In some demonstrative aspects, application 160, e.g., back-end 164, may be configured to determine the risk information 172, for example, based on the declared section code 126 for the goods, e.g., as described below.

In some demonstrative aspects, application 160, e.g., back-end 164, may be configured to determine the risk information 172, for example, based on the tariff information 129, e.g., as described below.

In some demonstrative aspects, application 160, e.g., back-end 164, may be configured to determine the risk information 172, for example, based on the country-of-origin information 128, e.g., as described below.

In some demonstrative aspects, application 160, e.g., back-end 164, may be configured to preprocess the declared description 122 of the goods, for example, to determine a preprocessed description 152 of the goods, which may be configured according to a predefined input format, e.g., as described below.

In some demonstrative aspects, the predefined input format may be configured, for example, for determination of the predicted HS code 178, e.g., as described below.

In some demonstrative aspects, the one or more processors 155 may include a preprocessor 150, which may be configured to determine the preprocessed description 152 of the goods, for example, based on the declared description 122 of the goods.

In some demonstrative aspects, preprocessor 150 may be implemented using any suitable hardware components and/or software components, for example, processors, controllers, memory units, storage units, input units, output units, communication units, operating systems, and/or applications.

In some demonstrative aspects, application 160, e.g., back-end 164, may be configured to determine the predicted HS code 178, for example, based on the preprocessed description 152 of the goods, e.g., as described below.

In some demonstrative aspects, the preprocessing of the declared description 122 may include, for example, a language preprocessing, for example, to modify a language of the declared description 122, for example, according to a language of the importer country, e.g., as described below.

In some demonstrative aspects, the preprocessing of the declared description 122 may include, for example, a text preprocessing, for example, to modify one or more text structures of the declared description 122, e.g., as described below.

In some demonstrative aspects, the preprocessing of the declared description 122 may include, for example, a cleansing preprocessing, for example, to cleanse words in the declared description 122, e.g., as described below.

In other aspects, the preprocessing of the declared description 122 may include any other additional or alternative adjustment, configuration, modification, preprocessing, and/or change of the declared description 122.

In some demonstrative aspects, application 160, e.g., back-end 164, may be configured to process the declared goods information 125, for example, to identify a declared section code 126 for the goods, e.g., as described below.

In some demonstrative aspects, application 160, e.g., back-end 164, may be configured to determine one or more potential section codes 138, for example, based on the declared description 122 of the goods, e.g., as described below.

In some demonstrative aspects, application 160, e.g., back-end 164, may be configured to determine the risk information 172, for example, based on the one or more potential section codes 138 and the declared section code 126, e.g., as described below.

In some demonstrative aspects, application 160, e.g., back-end 164, may be configured to determine a plurality of section-code scores corresponding to a plurality of predefined section codes, e.g., as described below.

In some demonstrative aspects, a section-code score corresponding to a predefined section code may be based, for example, on a correlation between the declared description 122 of the goods and the predefined section code, e.g., as described below.

In some demonstrative aspects, application 160, e.g., back-end 164, may be configured to select the one or more potential section codes 138 from the plurality of predefined section codes, for example, based on the plurality of section-code scores, e.g., as described below.

In some demonstrative aspects, application 160, e.g., back-end 164, may be configured to select the one or more potential section codes 138, for example, based on a comparison between the plurality of section-code scores and a predefined section-code threshold, e.g., as described below.

In some demonstrative aspects, the one or more processors 155 may include at least one processor 130, which may be configured to determine the one or more potential section codes 138, for example, based on the declared description 122 of the goods.

In some demonstrative aspects, processor 130 may be implemented using any suitable hardware components and/or software components, for example, processors, controllers, memory units, storage units, input units, output units, communication units, operating systems, and/or applications.

In some demonstrative aspects, application 160, e.g., back-end 164, may be configured to determine the plurality of section-code scores, for example, based on a Machine Learning (ML) output 136 of a ML engine 135, which may be trained to generate the ML output 136, for example, based on an ML input 132, e.g., as described below.

In some demonstrative aspects, the ML input 132 may be based, for example, on the declared description 122 of the goods, e.g., as described below.

In some demonstrative aspects, the ML output 136 may include the plurality of section-code scores corresponding to the plurality of predefined section codes, e.g., as described below.

In some demonstrative aspects, application 160, e.g., back-end 164, may be configured to preprocess the declared description 122 of the goods to determine the preprocessed description 152 of the goods, which may be configured according to a predefined input format of the ML input 132, e.g., as described below.

In some demonstrative aspects, application 160, e.g., back-end 164, may be configured to provide the preprocessed description 152 of the goods as the ML input 132 to the ML engine 135, e.g., as described below.

In some demonstrative aspects, the ML engine 135 may include a Large Language Model (LLM) ML engine 135.

In other aspects, the ML engine 135 may include any other additional and/or alternative type of ML engine.

In some demonstrative aspects, the ML engine 135 may be implemented, for example, based on a Neural-Network (NN) 137, and/or any other additional or alternative suitable ML mechanism.

In some demonstrative aspects, application 160, e.g., back-end 164, may be configured to determine the plurality of section-code scores, for example, based on an NN output of the NN 137, e.g., output 136. For example,—the NN 137 may be trained to generate the NN output, for example, based on an NN input, e.g., the input 132, e.g., as described below.

In some demonstrative aspects, the NN input of NN 137 may be based, for example, on the declared description 122 of the goods, e.g., as described below.

In some demonstrative aspects, the NN output of NN 137 may include the plurality of section-code scores corresponding to the plurality of predefined section codes, e.g., as described below.

In some demonstrative aspects, application 160, e.g., back-end 164, may be configured to preprocess the declared description 122 of the goods to determine the preprocessed description 152 of the goods, which may be configured according to a predefined input format of the NN input of NN 137, e.g., as described below.

In some demonstrative aspects, application 160, e.g., back-end 164, may be configured to provide the preprocessed description 152 of the goods as the NN input to the NN 137, e.g., as described below.

In some demonstrative aspects, processor 130 may include, and/or may implement one or more operations and/or functionalities of, ML engine 135.

For example, processor 130 may include, and/or may implement one or more operations and/or functionalities of, an LLM ML engine 135.

For example, processor 130 may include, and/or may implement one or more operations and/or functionalities of, NN 137.

In some demonstrative aspects, application 160, e.g., back-end 164, may be configured to determine one or more potential section-related HS codes 148, for example, based on the one or more potential section codes 138 and the declared description 122 of the goods, e.g., as described below.

In some demonstrative aspects, application 160, e.g., back-end 164, may be configured to determine the predicted HS code 178, for example, based on the one or more potential section-related HS codes 148, e.g., as described below.

In some demonstrative aspects, the one or more processors 155 may include at least one processor 140, which may be configured to determine the one or more potential section-related HS codes 148, for example, based on the one or more potential section codes 138 and the declared description 122 of the goods, e.g., as described below.

In some demonstrative aspects, application 160, e.g., back-end 164, may be configured to determine a plurality of HS-code scores corresponding to one or more pluralities of predefined section-related HS codes, e.g., as described below.

In some demonstrative aspects, the one or more pluralities of predefined section-related HS codes may correspond, for example, to the one or more potential section codes 138, e.g., as described below.

In some demonstrative aspects, an HS-code score corresponding to a predefined section-related HS code, which corresponds to a potential section code, may be based, for example, on a correlation between the declared description 122 of the goods and the predefined section-related HS code corresponding to the potential section code, e.g., as described below.

In some demonstrative aspects, application 160, e.g., back-end 164, may be configured to determine the predicted HS code 178, for example, based on the plurality of HS-code scores, e.g., as described below.

In some demonstrative aspects, application 160, e.g., back-end 164, may be configured to determine the predicted HS code 178, for example, based on a highest score of the plurality of HS-code scores, e.g., as described below.

In other aspects, application 160, e.g., back-end 164, may be configured to determine the predicted HS code 178 based on any other suitable additional or alternative selection criteria applied to the plurality of HS-code scores.

In some demonstrative aspects, application 160, e.g., back-end 164, may be configured to determine the plurality of HS-code scores corresponding to the one or more pluralities of predefined section-related HS codes, for example, based on one or more ML outputs 147 of one or more ML engines 141 corresponding to the one or more potential section codes 138, e.g., as described below.

In some demonstrative aspects, an ML engine 145 corresponding to a potential section code may be trained to generate an ML output 146 corresponding to the potential section code, for example, based on an ML input 142, e.g., as described below.

In some demonstrative aspects, the ML input 142 may be based, for example, on the declared description 122 of the goods, e.g., as described below.

In some demonstrative aspects, the ML output 146 corresponding to the potential section code may include, for example, a plurality of HS-code scores corresponding to a plurality of predefined section-related HS codes corresponding to the potential section code, e.g., as described below.

In some demonstrative aspects, application 160, e.g., back-end 164, may be configured to select the one or more ML engines 141 from a plurality of ML engines 144, for example, based on the one or more potential section codes 138, e.g., as described below.

In some demonstrative aspects, the plurality of ML engines 144 may correspond, for example, to a plurality of predefined section codes, e.g., as described below.

For example, an ML engine, e.g., each ML engine, of the plurality of ML engines 144 may be trained to generate an ML output corresponding to a respective predefined section code of the plurality of predefined section codes, e.g., as described below.

For example, the ML engine may be configured to generate the ML output to include a plurality of HS-code scores corresponding to a plurality of predefined section-related HS codes corresponding to the predefined section code, e.g., as described below.

In some demonstrative aspects, application 160, e.g., back-end 164, may be configured to select a first set of one or more first ML engines 141 from the plurality of ML engines 144, for example, based on a determination of one or more first potential section codes 138, e.g., as described below.

In some demonstrative aspects, application 160, e.g., back-end 164, may be configured to determine a first predicted HS code 178, for example, based on ML outputs of the one or more first ML engines 141, e.g., as described below.

In some demonstrative aspects, application 160, e.g., back-end 164, may be configured to select a second set of one or more second ML engines 141 from the plurality of ML engines 144, for example, based on a determination of one or more second potential section codes 138, e.g., as described below.

In some demonstrative aspects, application 160, e.g., back-end 164, may be configured to determine a second predicted HS code 178, for example, based on ML outputs of the one or more second ML engines 141, e.g., as described below.

In some demonstrative aspects, the one or more second potential section codes may be different from the one or more first potential section codes, e.g., as described below.

In some demonstrative aspects, the first set of one or more second ML engines may be different from the second set of one or more first ML engines, e.g., as described below.

In some demonstrative aspects, application 160, e.g., back-end 164, may be configured to preprocess the declared description 122 of the goods to determine the preprocessed description 152 of the goods, e.g., as described below.

In some demonstrative aspects, the preprocessed description 152 of the goods may be configured, for example, according to a predefined input format of the ML input 142, e.g., as described below.

In some demonstrative aspects, application 160, e.g., back-end 164, may be configured to provide the preprocessed description 152 of the goods as the one or more ML inputs 143 to the one or more ML engines 141, e.g., as described below.

In some demonstrative aspects, the ML engine 145 may include a LLM ML engine 145.

In other aspects, the ML engine 145 may include any other additional and/or alternative type of ML engine.

In some demonstrative aspects, the ML engine 145 may be implemented, for example, based on a NN 149, and/or any other additional or alternative suitable ML mechanism.

In some demonstrative aspects, application 160, e.g., back-end 164, may be configured to determine the plurality of HS-code scores corresponding to the one or more pluralities of predefined section-related HS codes, for example, based on one or more NN outputs of one or more NNs 149, e.g., output 147, corresponding to the one or more potential section codes 138, e.g., as described below.

In some demonstrative aspects, an NN 149 corresponding to a potential section code may be trained to generate an NN output, e.g., output 147, corresponding to the potential section code, e.g., as described below.

In some demonstrative aspects, the NN 149 corresponding to a potential section code may be trained to generate the NN output, e.g., output 147, corresponding to the potential section code, for example, based on an NN input of NN 149, e.g., input 142, e.g., as described below.

In some demonstrative aspects, the NN input of NN 149, e.g., input 142, may be based, for example, on the declared description 122 of the goods, e.g., as described below.

In some demonstrative aspects, the NN output of the NN 149, e.g., output 147, corresponding to the potential section code may include the plurality of HS-code scores corresponding to the plurality of predefined section-related HS codes corresponding to the potential section code, e.g., as described below.

In some demonstrative aspects, application 160, e.g., back-end 164, may be configured to preprocess the declared description 122 of the goods to determine the preprocessed description 152 of the goods, e.g., as described below.

In some demonstrative aspects, the preprocessed description 152 of the goods may be configured, for example, according to a predefined input format of the NN input of the NN 149, e.g., as described below.

In some demonstrative aspects, application 160, e.g., back-end 164, may be configured to provide the preprocessed description 152 of the goods as the one or more NN inputs to the one or more NNs 149, e.g., as described below.

In some demonstrative aspects, processor 140 may include, and/or may implement one or more operations and/or functionalities of, ML engine 145.

For example, processor 140 may include, and/or may implement one or more operations and/or functionalities of, an LLM ML engine 145.

For example, processor 140 may include, and/or may implement one or more operations and/or functionalities of, NN 149.

In some demonstrative aspects, application 160, e.g., back-end 164, may be configured to determine a predicted section code 176, for example, based on the one or more potential section codes 138, e.g., as described below.

In some demonstrative aspects, application 160, e.g., back-end 164, may be configured to determine the risk information 172, for example, based on a section mismatch between the declared section code 126 and the predicted section code 176, e.g., as described below.

In some demonstrative aspects, application 160, e.g., back-end 164, may be configured to determine the predicted section code 176, for example, based on the predicted HS code 178, e.g., as described below.

In some demonstrative aspects, the risk information 172 may include section-code-mismatch information to indicate a section-code-mismatch risk, for example, based on the section mismatch between the declared section code 126 and the predicted section code 176, e.g., as described below.

In some demonstrative aspects, application 160, e.g., back-end 164, may be configured to provide the output including the vetting information 167 including, for example, the predicted section code 176, e.g., as described below.

In some demonstrative aspects, application 160, e.g., back-end 164, may be configured to determine the risk information 172 including an indication that the declared description 122 of the goods is indefinite, for example, based on a determination that the declared description 122 of the goods is not specific enough to determine the predicted HS code 178, e.g., as described below.

In some demonstrative aspects, application 160, e.g., back-end 164, may be configured to provide the output including the vetting information 167 including, for example, predicted tariff information 179 corresponding to a tariff, e.g., a predicted tariff, for the predicted HS code 178, e.g., as described below.

In some demonstrative aspects, the risk information 172 may include tariff-mismatch information to indicate a tariff risk, for example, based on a mismatch between a first tariff, e.g., the declared tariff 129, for the declared HS code 124, and a second tariff, e.g., the predicted tariff, for the predicted HS code 178, e.g., as described below.

In some demonstrative aspects, the risk information 172 may include HS-code-mismatch information to indicate an HS-code-mismatch risk, for example, based on the mismatch between the declared HS code 124 and the predicted HS code 178, e.g., as described below.

In some demonstrative aspects, the risk information 172 may include HS header (HS2) code-mismatch (HS-code-mismatch) information to indicate an HS2-code-mismatch risk, for example, based on a mismatch between a declared HS code of the declared HS code 124 and a predicted HS code of the predicted HS code 178, e.g., as described below.

In some demonstrative aspects, the risk information 172 may include regulatory-risk information, e.g., as described below.

In some demonstrative aspects, the regulatory-risk information may be configured, for example, to indicate a regulatory risk, for example, based on a mismatch between first regulations for the declared HS code 124 and second regulations for the predicted HS code 178, e.g., as described below.

In some demonstrative aspects, application 160, e.g., back-end 164, may be configured to send the vetting information 167 to computing device 102, e.g., as described below.

In some demonstrative aspects, application 160, e.g., front-end 162, may be configured to control, cause and/or instruct GUI 116 to present the vetting information 167 to the user, e.g., as described below.

In some demonstrative aspects, application 160, e.g., front-end 166, may be configured to present the vetting information 167 to the user, for example, via GUI 116, e.g., as described below.

In some demonstrative aspects, application 160, e.g., front-end 162, may be configured to process the vetting information 167 from the server 170, for example, to identify the predicted HS code 178 corresponding to the declared description 122 of the goods, e.g., as described below.

In some demonstrative aspects, application 160, e.g., front-end 162, may be configured to identify the risk information 172 to indicate the one or more risks corresponding to the declaration fraud, for example, based on the mismatch between the declared HS code 124 and the predicted HS code 178, e.g., as described below.

In some demonstrative aspects, application 160, e.g., front-end 162, may be configured to provide the GUI 116, which may be configured to present the shipment vetting information 167 to the user, e.g., as described below.

In some demonstrative aspects, application 160, e.g., front-end 162, may be configured to process the vetting information 167 from the server 170, for example, to identify the tariff-mismatch information, which may indicate the tariff risk, for example, based on the mismatch between the first tariff, e.g., the declared tariff 129, for the declared HS code 124, and the second tariff, e.g., the predicted tariff for the predicted HS code 178, e.g., as described below.

In some demonstrative aspects, application 160, e.g., front-end 162, may be configured to cause the GUI 116 to present the second tariff, e.g., the predicted tariff for the predicted HS code 178, and the tariff-mismatch information, e.g., as described below.

In some demonstrative aspects, application 160, e.g., front-end 162, may be configured to process the vetting information 167 from the server 170, for example, to identify the predicted section code 176 corresponding to the declared description 122 of the goods, and the section-code-mismatch information, which may indicate the section-code-mismatch risk based on the mismatch between the declared section code 126 of the goods and the predicted section code 176, e.g., as described below.

In some demonstrative aspects, application 160, e.g., front-end 162, may be configured to cause the GUI 116 to present the predicted section code 176 and the section-code-mismatch information, e.g., as described below.

In some demonstrative aspects, application 160, e.g., front-end 162, may be configured to process the vetting information 167 from the server 170, for example, to identify the regulatory-risk information to indicate a regulatory risk based on the mismatch between first regulations for the declared HS code 124 and the second regulations for the predicted HS code 178, e.g., as described below.

In some demonstrative aspects, application 160, e.g., front-end 162, may be configured to cause the GUI 116 to present the regulatory-risk information, e.g., as described below.

In some demonstrative aspects, application 160, e.g., front-end 162, may be configured to process the vetting information 167 from the server 170, for example, to identify the indication that the declared description 122 of the goods is indefinite, for example, that the declared description 122 of the goods is not specific enough to determine the predicted HS code 178, e.g., as described below.

In some demonstrative aspects, application 160, e.g., front-end 162, may be configured to cause the GUI 116 to present the indication that the declared description 122 of the goods is indefinite, e.g., as described below.

In some demonstrative aspects, application 160, e.g., front-end 162, may be configured to process first vetting information 167 from the server 170. For example, the first vetting information 167 from the server 170 may correspond to first goods in a shipment.

In some demonstrative aspects, application 160, e.g., front-end 162, may be configured to process the first vetting information 167 from the server 170, for example, to identify a first predicted HS code 178 and first risk information 172 corresponding to the first predicted HS code 178, for example, for the first goods, e.g., as described below.

In some demonstrative aspects, application 160, e.g., front-end 162, may be configured to cause the GUI 116 to present the first shipment vetting information 167 to the user, e.g., as described below.

In some demonstrative aspects, application 160, e.g., front-end 162, may be configured to process second vetting information 167 from the server 170. For example, the second vetting information 167 from the server 170 may correspond to second goods in the shipment.

In some demonstrative aspects, application 160, e.g., front-end 162, may be configured to process the second vetting information 167 from the server 170, for example, to identify a second predicted HS code 178 and second risk information 172 corresponding to the second predicted HS code 178, for example, for the first goods, e.g., as described below.

In some demonstrative aspects, application 160, e.g., front-end 162, may be configured to cause the GUI 116 to present the second shipment vetting information 167 to the user, e.g., as described below.

In some demonstrative aspects, the second shipment vetting information 167 may be different from the first shipment vetting information 167, e.g., as described below.

In some demonstrative aspects, the second predicted HS code 178 may be different from the first predicted HS code 178, e.g., as described below.

In some demonstrative aspects, the second risk information 172 may be different from the first risk information 172, e.g., as described below.

In some demonstrative aspects, back-end 164 may be configured as a client-based application, which may be installed on computing device 102.

In some demonstrative aspects, the client-based application may be configured to provide a user interface for one or more users, for example, to vet, inspect, and/or analyze goods of a plurality of imported shipments, e.g., as described above.

In some demonstrative aspects, the client-based application may be configured to provide a user interface for the user, for example, to output and/or display the vetting information 167 for the goods of the imported shipment, e.g., as described above.

In some demonstrative aspects, the client-based application may be configured to provide the user interface to support any other additional and/or alternative inputs and/or outputs.

In some demonstrative aspects, the back-end 164 of application 160 may be configured as a server-based application, which may be implemented, for example, by server 170.

In some demonstrative aspects, the server-based application may be configured to control one or more functionalities and/or operations of a shipment analyzer, e.g., as described above.

In some demonstrative aspects, the server-based application may be configured to analyze raw data in the shipment documentation, e.g., the declared goods information 125, of the imported shipment, e.g., as described above.

In some demonstrative aspects, the server-based application may be configured to determine the vetting information 167, for example, based on analysis of the declared goods information 125, e.g., as described above.

In other aspects, the server-based application may be configured to control one or more additional and/or alternative functionalities and/or operations of the shipment-analyzer.

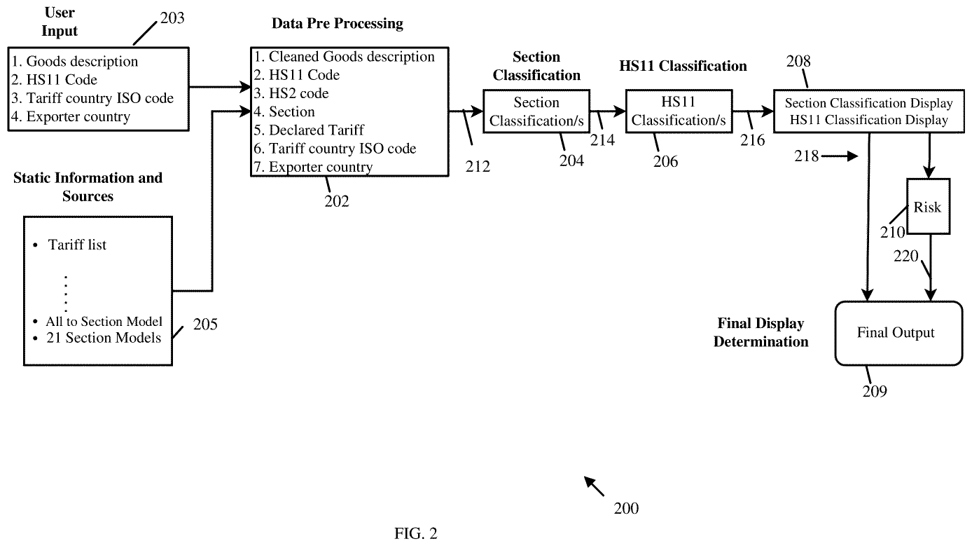

Reference is made to FIG. 2, which schematically illustrates a flow chart of a method 200 of determining vetting information for goods of an imported shipment, in accordance with some demonstrative aspects. For example, one or more of the operations of the method of FIG. 2 may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, as indicated at block 202, the method may include preprocessing declared goods information 203 to determine preprocessed goods information 212. For example, application 160 (FIG. 1), e.g., back-end 164 (FIG. 1), may be configured to preprocess the declared goods information 125 (FIG. 1) of the goods of the imported shipment, for example, to determine preprocessed goods information 212, e.g., as described above.

In some demonstrative aspects, as shown in FIG. 2, the declared goods information 203 may include a declared description of the goods, a declared HS code for the goods, a country code, e.g., the tariff country ISO code, and/or country-of-origin information corresponding to an exporter country of the imported shipment, e.g., as described above.

In some demonstrative aspects, as indicated at block 202, the preprocessing of the declared goods information 203 may be based on external information 205. For example, the external information 205 may include a tariff list, information of section models, e.g., 21 section models or any other number of section models, customs information, and/or the like.

In some demonstrative aspects, as indicated at block 202, the preprocessing of the declared goods information 203 may include preprocessing of the declared description of the goods, for example, to determine a preprocessed description of the goods, e.g., a cleansed goods description. For example, application 160 (FIG. 1), e.g., back-end 164 (FIG. 1), may be configured to preprocess the declared description 122 (FIG. 1) of the goods, for example, to determine the preprocessed description 152 (FIG. 1) of the goods, e.g., as described above.

In some demonstrative aspects, as indicated at block 202, the preprocessing of the declared goods information 203 may include identifying the declared HS code for the goods. For example, application 160 (FIG. 1), e.g., back-end 164 (FIG. 1), may be configured to preprocess the declared goods information 125 (FIG. 1), for example, to identify the declared HS code 124 (FIG. 1), e.g., as described above.

In some demonstrative aspects, as indicated at block 202, the preprocessing of the declared goods information may include identifying a declared header code for the goods. For example, application 160 (FIG. 1), e.g., back-end 164 (FIG. 1), may be configured to preprocess the declared goods information 125 (FIG. 1), for example, to identify the declared header code for the goods.

In some demonstrative aspects, as indicated at block 202, the preprocessing of the declared goods information 203 may include identifying the declared section code for the goods. For example, application 160 (FIG. 1), e.g., back-end 164 (FIG. 1), may be configured to preprocess the declared goods information 125 (FIG. 1), for example, to identify the declared section code 126 (FIG. 1), e.g., as described above.

In some demonstrative aspects, as indicated at block 202, the preprocessing of the declared goods information 203 may include determining a declared tariff for the goods. For example, application 160 (FIG. 1), e.g., back-end 164 (FIG. 1), may be configured to preprocess the declared goods information 125 (FIG. 1), for example, to determine the declared tariff 129 (FIG. 1), e.g., as described above.

In some demonstrative aspects, as indicated at block 202, the preprocessing of the declared goods information 203 may include identifying the country code for the goods, e.g., the tariff country ISO code. For example, application 160 (FIG. 1), e.g., back-end 164 (FIG. 1), may be configured to preprocess the declared goods information 125 (FIG. 1), for example, to identify the country code 127 (FIG. 1), e.g., as described above.

In some demonstrative aspects, as indicated at block 202, the preprocessing of the declared goods information may include identifying the country of origin (exporter country) of the imported shipment. For example, application 160 (FIG. 1), e.g., back-end 164 (FIG. 1), may be configured to preprocess the declared goods information 125 (FIG. 1), for example, to identify the country-of-origin information 128 (FIG. 1) corresponding to the country of origin of the imported shipment, e.g., as described above.

In some demonstrative aspects, as indicated at block 204, the method may include determining one or more potential section codes 214, for example, based on the preprocessed goods information 212, e.g., based on the preprocessed description of the goods. For example, application 160 (FIG. 1), e.g., back-end 164 (FIG. 1), may be configured to determine the one or more potential section codes 138 (FIG. 1), for example, based on the preprocessed description 152 (FIG. 1) of the goods, e.g., as described above.

In some demonstrative aspects, as indicated at block 206, the method may include determining one or more potential section-related HS codes 216, for example, based on the one or more potential section codes 214 and the preprocessed goods information 212, e.g., the preprocessed description of the goods. For example, application 160 (FIG. 1), e.g., back-end 164 (FIG. 1), may be configured to determine the one or more potential section-related HS codes 148 (FIG. 1), for example, based on the one or more potential section codes 138 (FIG. 1) and the preprocessed description 152 (FIG. 1) of the goods, e.g., as described above.

In some demonstrative aspects, as indicated at block 208, the method may include determining predicted classification information 218, for example, based on the one or more potential section codes 214.

In some demonstrative aspects, as indicated at block 208, the method may include determining the predicted classification information 218 including a predicted section code, for example, based on the one or more potential section codes 214. For example, application 160 (FIG. 1), e.g., back-end 164 (FIG. 1), may be configured to determine the predicted section code 176 (FIG. 1), for example, based on the one or more potential section codes 138 (FIG. 1), e.g., as described above.

In some demonstrative aspects, as indicated at block 208, the method may include determining the predicted classification information 218 including a predicted HS code, for example, based on the one or more potential section-related HS codes 216. For example, application 160 (FIG. 1), e.g., back-end 164 (FIG. 1), may be configured to determine the predicted HS code 178 (FIG. 1), for example, based on the one or more potential section-related HS codes 148 (FIG. 1), e.g., as described above.

In some demonstrative aspects, as indicated at block 210, the method may include determining risk information 220, for example, based on the predicted information 218, e.g., including the predicted section code and/or the predicted HS code. For example, application 160 (FIG. 1), e.g., back-end 164 (FIG. 1), may be configured to determine the risk information 172 (FIG. 1), for example, based on the predicted HS code 178 (FIG. 1) and/or the predicted section code 176 (FIG. 1), e.g., as described above.

In some demonstrative aspects, application 160 (FIG. 1), e.g., back-end 164 (FIG. 1), may be configured to determine the risk information 220 to indicate one or more risks corresponding to a declaration fraud, for example, based on a mismatch between the declared HS code and the predicted HS code.

In some demonstrative aspects, application 160 (FIG. 1), e.g., back-end 164 (FIG. 1), may be configured to determine the risk information 220 to indicate one or more risks corresponding to the declaration fraud, for example, based on a mismatch between the declared section code and the predicted section code.

In some demonstrative aspects, as indicated at block 209, the method may include providing an output including vetting information including the risk information 220, and the predicted classification information 218, e.g., including the predicted section code and/or the predicted HS code. For example, application 160 (FIG. 1), e.g., back-end 164 (FIG. 1), may be configured to provide the output including the vetting information 167 (FIG. 1) including the risk information 172 (FIG. 1), the predicted section code 176 (FIG. 1), and/or the predicted HS code 178 (FIG. 1), e.g., as described above.

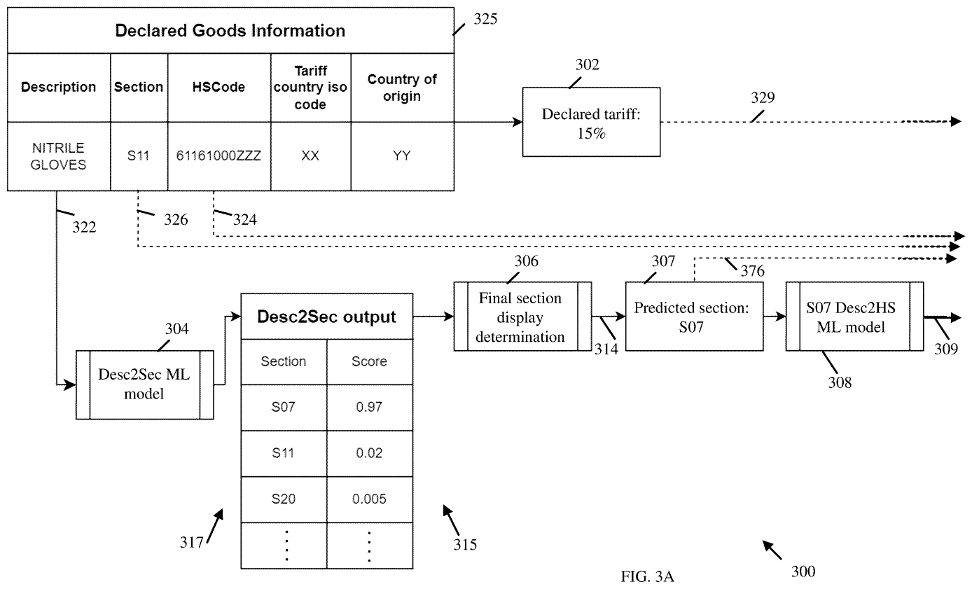

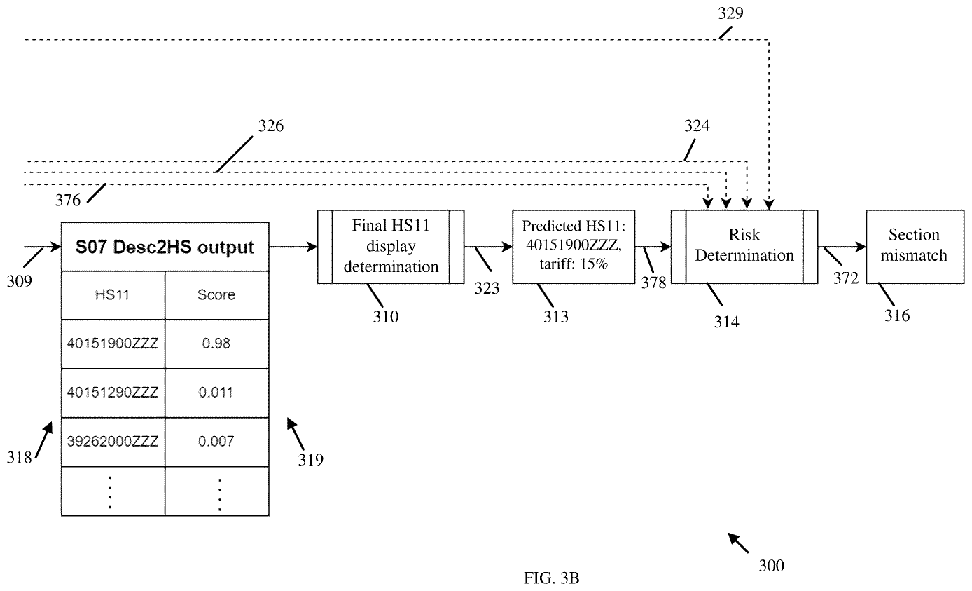

Reference is made to FIGS. 3A and 3B, which schematically illustrate a flow chart of a method 300 of providing vetting information based on declared goods information 325, in accordance with some demonstrative aspects. For example, one or more of the operations of the method of FIGS. 3A and 3B may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, as shown in FIG. 3A, the declared goods information 325 may include a declared description 322 of goods of an imported shipment, e.g., including the description “NITRILE GLOVES”.

In some demonstrative aspects, as shown in FIG. 3A, the declared goods information 325 may include a declared section code 326, e.g., including the declared section code “S11”.

In some demonstrative aspects, as shown in FIG. 3A, the declared goods information 303 may include a declared HS code 324, e.g., including the declared HS code “61161000ZZZ”.

In some demonstrative aspects, as shown in FIG. 3A, the declared goods information 325 may include a country code, e.g., a tariff country ISO code, and/or country-of-origin information corresponding to an exporter country of the imported shipment.

In some demonstrative aspects, as indicated at block 302, the method may include determining a declared tariff 329, e.g., 15%, for the goods, for example, based on the declared goods information 325. For example, application 160 (FIG. 1), e.g., back-end 164 (FIG. 1), may be configured to determine the declared tariff 329 based on the declared goods information 325.

In some demonstrative aspects, as indicated at block 304, the method may include determining a plurality of section-code scores 315 corresponding to a plurality of predefined section codes 317, for example, based on the declared description 322. For example, application 160 (FIG. 1), e.g., back-end 164 (FIG. 1), may be configured to determine the plurality of section-code scores 315 corresponding to the plurality of predefined section codes 317, for example, based on the declared description 322.

In one example, an ML engine may be configured to determine the plurality of section-code scores 315. For example, ML engine 135 (FIG. 1) may determine the plurality of section-code scores 315 corresponding to the plurality of predefined section codes 317, e.g., as described above.

In some demonstrative aspects, as indicated at block 306, the method may include determining one or more potential section codes 314, for example, based on the plurality of section-code scores 315 corresponding to the plurality of predefined section codes 317. For example, application 160 (FIG. 1), e.g., back-end 164 (FIG. 1), may be configured to determine the one or more potential section codes 314, for example, based on the plurality of section-code scores 315 corresponding to the plurality of predefined section codes 317, e.g., as described above.

In some demonstrative aspects, as indicated at block 307, the method may include determining a predicted section code 376, e.g., the section code “S07”, for example, based on the one or more potential section codes 314. For example, application 160 (FIG. 1), e.g., back-end 164 (FIG. 1), may be configured to determine the predicted section code 376, for example, based on the one or more potential section codes 314, e.g., as described above.

In one example, application 160 (FIG. 1), e.g., back-end 164 (FIG. 1), may be configured to determine the predicted section code 376, for example, based on a highest score of the plurality of section-code scores 315, e.g., as described above.

In some demonstrative aspects, as indicated at block 308, the method may include determining a plurality of HS-code scores 319 corresponding to a plurality of predefined section-related HS codes 318, which may correspond to the predicted section code 376, e.g., to the section code “S07”, for example, based on the declared description 322 of the goods. For example, application 160 (FIG. 1), e.g., back-end 164 (FIG. 1), may be configured to determine the plurality of HS-code scores 319 corresponding to the plurality of predefined section-related HS codes 318, for example, based on the predicted section code 376 and the declared description 322 of the goods.

In some demonstrative aspects, as indicated at block 308, the method may include providing the plurality of HS-code scores 319 corresponding to the plurality of predefined section-related HS codes 318, for example, by an output 309 of an ML engine, e.g., as described above.

In one example, an ML engine may be configured to provide the output 309 including the plurality of HS-code scores 319 corresponding to the plurality of predefined section-related HS codes 318. For example, an ML engine 145 (FIG. 1), which may correspond to the predicted section code 376, e.g., the section code “S07”, may determine the plurality of HS-code scores 319 corresponding to the plurality of predefined section-related HS codes 318, e.g., corresponding to the section code “S07”.

In some demonstrative aspects, as indicated at block 310, the method may include determining one or more potential section-related HS codes 323 corresponding to the predicted section code 376, e.g., the section code “S07”, for example, based on the plurality of HS-code scores 319 corresponding to the plurality of predefined section-related HS codes 318. For example, application 160 (FIG. 1), e.g., back-end 164 (FIG. 1), may be configured to determine the one or more potential section-related HS codes 323, for example, based on the plurality of HS-code scores 319 corresponding to the plurality of predefined section-related HS codes 318, e.g., as described above.

In some demonstrative aspects, as indicated at block 313, the method may include determining a predicted HS code 378, e.g., the predicted HS code “40151900ZZZ”, for example, based on the one or more potential section-related HS codes 323. For example, application 160 (FIG. 1), e.g., back-end 164 (FIG. 1), may be configured to determine the predicted HS code 378, e.g., the predicted HS code “40151900ZZZ”, for example, based on the one or more potential section-related HS codes 323, e.g., as described above.

In some demonstrative aspects, as indicated at block 313, the method may include determining a predicted tariff, e.g., 15%, corresponding to the predicted HS code 378. For example, application 160 (FIG. 1), e.g., back-end 164 (FIG. 1), may be configured to determine the predicted tariff, e.g., 15%, corresponding to the predicted HS code “40151900ZZZ”.

In some demonstrative aspects, as indicated at block 314, the method may include determining risk information 372, for example, based on the predicted section code 376, the predicted HS code 378, the declared section code 326, and the declared HS code 324. For example, application 160 (FIG. 1), e.g., back-end 164 (FIG. 1), may be configured to determine the risk information 172 (FIG. 1), for example, based on the predicted section code 476, the predicted HS code 478, the declared section code 426, and the declared HS code 424, e.g., as described above.

In some demonstrative aspects, as indicated at block 316, the method may include providing an output including vetting information including the risk information 372, for example, to indicate a section-code-mismatch risk corresponding to a declaration fraud, for example, based on a mismatch between the declared section code 326 and the predicted section code 376. For example, the declared section code 326, e.g., the section code “S11”, may be different from the predicted section code 376, e.g., the section code SO7”.

In some demonstrative aspects, application 160 (FIG. 1), e.g., back-end 164 (FIG. 1), may be configured to provide the output including the vetting information 167 (FIG. 1) including the risk information 372, which may be configured, for example, to indicate the section-code-mismatch risk corresponding to the mismatch between the declared section code 326, e.g., the section code “S11”, and the predicted section code 376, e.g., the section code “SO7”.

In some demonstrative aspects, application 160 (FIG. 1), e.g., back-end 162 (FIG. 1), may be configured to cause GUI 116 (FIG. 1) to present to a user the section-code-mismatch risk corresponding, for example, to the mismatch between the declared section code 326, e.g., the section code “S11”, and the predicted section code 376, e.g., the section code “SO7”.

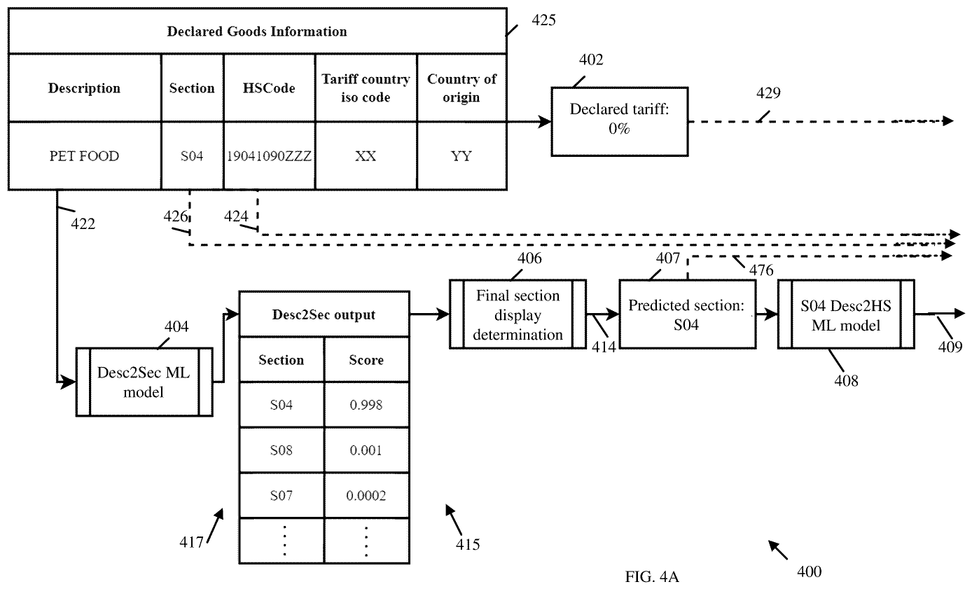

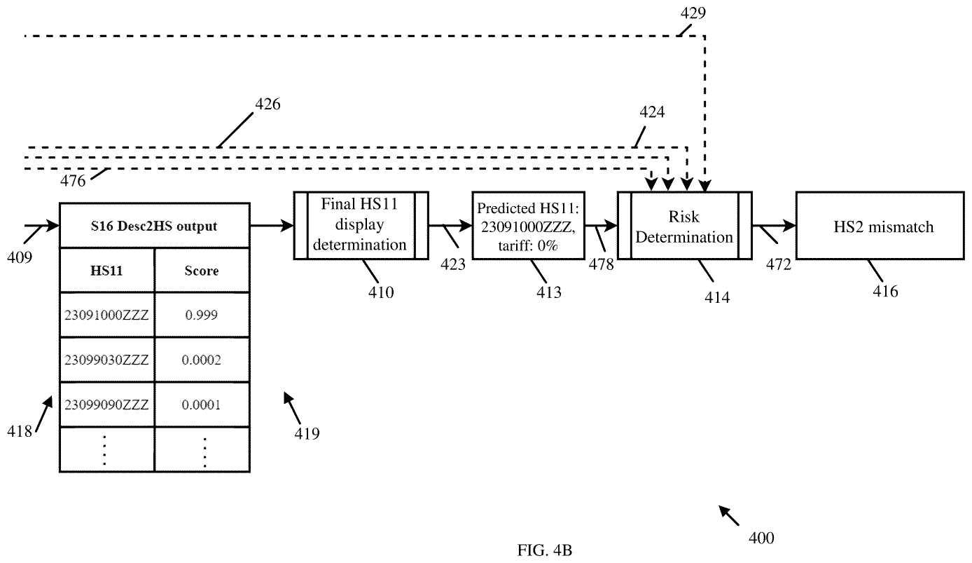

Reference is made to FIGS. 4B and 4B, which schematically illustrate a flow chart of a method 400 of providing vetting information based on declared goods information 425, in accordance with some demonstrative aspects. For example, one or more of the operations of the method of FIGS. 4A and 4B may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, as shown in FIG. 4A, the declared goods information 425 may include a declared description 422 of goods of an imported shipment, e.g., including the description “PET FOOD”.

In some demonstrative aspects, as shown in FIG. 4A, the declared goods information 425 may include a declared section code 426, e.g., including the declared section code “S04”.

In some demonstrative aspects, as shown in FIG. 4A, the declared goods information 425 may include a declared HS code 424, e.g., including the declared HS code “19041090ZZZ”.

In some demonstrative aspects, as shown in FIG. 4A, the declared goods information 425 may include a country code, e.g., a tariff country ISO code, and/or country-of-origin information corresponding to an exporter country of the imported shipment.

In some demonstrative aspects, as indicated at block 402, the method may include determining a declared tariff 429, e.g., 0%, for the goods, for example, based on the declared goods information 425. For example, application 160 (FIG. 1), e.g., back-end 164 (FIG. 1), may be configured to determine the declared tariff 429, e.g., 0%, for the goods based on the declared goods information 425.

In some demonstrative aspects, as indicated at block 404, the method may include determining a plurality of section-code scores 415 corresponding to a plurality of predefined section codes 417, for example, based on the declared description 422. For example, application 160 (FIG. 1), e.g., back-end 164 (FIG. 1), may be configured to determine the plurality of section-code scores 415 corresponding to the plurality of predefined section codes 417, for example, based on the declared description 422.

In one example, an ML engine may be configured to determine the plurality of section-code scores 415. For example, ML engine 135 (FIG. 1) may determine the plurality of section-code scores 415 corresponding to the plurality of predefined section codes 417, e.g., as described above.

In some demonstrative aspects, as indicated at block 406, the method may include determining one or more potential section codes 414, for example, based on the plurality of section-code scores 415 corresponding to the plurality of predefined section codes 417. For example, application 160 (FIG. 1), e.g., back-end 164 (FIG. 1), may be configured to determine the one or more potential section codes 414, for example, based on the plurality of section-code scores 415 corresponding to the plurality of predefined section codes 417, e.g., as described above.

In some demonstrative aspects, as indicated at block 407, the method may include determining a predicted section code 476, e.g., the section code “S04”, for example, based on the one or more potential section codes 414. For example, application 160 (FIG. 1), e.g., back-end 164 (FIG. 1), may be configured to determine the predicted section code 476, for example, based on the one or more potential section codes 414, e.g., as described above.

In one example, application 160 (FIG. 1), e.g., back-end 164 (FIG. 1), may be configured to determine the predicted section code 476, for example, based on a highest score of the plurality of section-code scores 415, e.g., as described above.

In one example, application 160 (FIG. 1), e.g., back-end 164 (FIG. 1), may be configured to determine that there is no mismatch between the predicted section code 476, e.g., the section code “S04”, and the declared section code 426, e.g., the section code “S04”.

In some demonstrative aspects, as indicated at block 408, the method may include determining a plurality of HS-code scores 419 corresponding to a plurality of predefined section-related HS codes 418, which may correspond to the predicted section code 476, e.g., to the section code “S04”, for example, based on the declared description 422 of the goods. For example, application 160 (FIG. 1), e.g., back-end 164 (FIG. 1), may be configured to determine the plurality of HS-code scores 419 corresponding to the plurality of predefined section-related HS codes 418, for example, based on the predicted section code 476 and the declared description 422 of the goods.

In some demonstrative aspects, as indicated at block 408, the method may include providing the plurality of HS-code scores 419 corresponding to the plurality of predefined section-related HS codes 418, for example, by an output 409 of an ML engine, e.g., as described above.

In one example, an ML engine may be configured to provide the output 409 including the plurality of HS-code scores 419 corresponding to the plurality of predefined section-related HS codes 418. For example, an ML engine 145 (FIG. 1), which may correspond to the predicted section code 476, e.g., the section code “S04”, may be configured to determine the plurality of HS-code scores 419 corresponding to the plurality of predefined section-related HS codes 418, e.g., corresponding to the section code “S04”.

In some demonstrative aspects, as indicated at block 410, the method may include determining one or more potential section-related HS codes 423 corresponding to the predicted section code 476, e.g., the section code “S04”, for example, based on the plurality of HS-code scores 419 corresponding to the plurality of predefined section-related HS codes 418. For example, application 160 (FIG. 1), e.g., back-end 164 (FIG. 1), may be configured to determine the one or more potential section-related HS codes 423, for example, based on the plurality of HS-code scores 419 corresponding to the plurality of predefined section-related HS codes 418, e.g., as described above.

In some demonstrative aspects, as indicated at block 413, the method may include determining a predicted HS code 478, e.g., the predicted HS code “23091000ZZZ”, for example, based on the one or more potential section-related HS codes 423. For example, application 160 (FIG. 1), e.g., back-end 164 (FIG. 1), may be configured to determine the predicted HS code 478, e.g., the predicted HS code “23091000ZZZ”, for example, based on the one or more potential section-related HS codes 423, e.g., as described above.

In some demonstrative aspects, as indicated at block 413, the method may include determining a predicted tariff, e.g., 0%, corresponding to the predicted HS code 478. For example, application 160 (FIG. 1), e.g., back-end 164 (FIG. 1), may be configured to determine the predicted tariff, e.g., 0%, corresponding to the predicted HS code “23091000ZZZ”.

In some demonstrative aspects, as indicated at block 414, the method may include determining risk information 472, for example, based on the predicted section code 476, the predicted HS code 478, the declared section code 426, and the declared HS code 424. For example, application 160 (FIG. 1), e.g., back-end 164 (FIG. 1), may be configured to determine the risk information 172 (FIG. 1), for example, based on the predicted section code 476, the predicted HS code 478, the declared section code 426, and the declared HS code 424, e.g., as described above.

In some demonstrative aspects, as indicated at block 416, the method may include providing an output including vetting information including the risk information 372, for example, to indicate an HS-code-mismatch risk corresponding to a declaration fraud, for example, based on a mismatch between the declared HS code 424 and the predicted HS code 478. For example, the declared HS code 424, e.g., the declared HS code “19041090ZZZ”, may be different from the predicted HS code 478, e.g., the predicted HS code “23091000ZZZ”.

In some demonstrative aspects, application 160 (FIG. 1), e.g., back-end 164 (FIG. 1), may be configured to provide the output including the vetting information 167 (FIG. 1) including the risk information 472 (FIG. 1), which may be configured, for example, to indicate the HS-code-mismatch risk corresponding to the mismatch between the declared HS code 424, e.g., the declared HS code “19041090ZZZ”, and the predicted HS code 478, e.g., the predicted HS code “23091000ZZZ”.

In some demonstrative aspects, application 160 (FIG. 1), e.g., back-end 162 (FIG. 1), may be configured to cause GUI 116 (FIG. 1) to present to a user the HS-code-mismatch risk, for example, based on the mismatch between the declared HS code 424, e.g., the declared HS code “19041090ZZZ”, and the predicted HS code 478, e.g. the predicted HS code “23091000ZZZ”.

In some demonstrative aspects, application 160 (FIG. 1), e.g., back-end 164 (FIG. 1), may be configured to provide the output including the vetting information 167 (FIG. 1) including the risk information 472 (FIG. 1), which may be configured, for example, to indicate the HS2-code-mismatch risk based on the mismatch between the header “19” of the declared HS code “19041090ZZZ” and the header “23” of the predicted HS code “23091000ZZZ”.

In some demonstrative aspects, application 160 (FIG. 1), e.g., back-end 162 (FIG. 1), may be configured to cause GUI 116 (FIG. 1) to present to a user the HS2-code-mismatch risk, for example, based on the mismatch between the header “19” of the declared HS code 424, e.g., the declared HS code “19041090ZZZ”, and the header “23” of the predicted HS code 478, e.g. the predicted HS code “23091000ZZZ”.

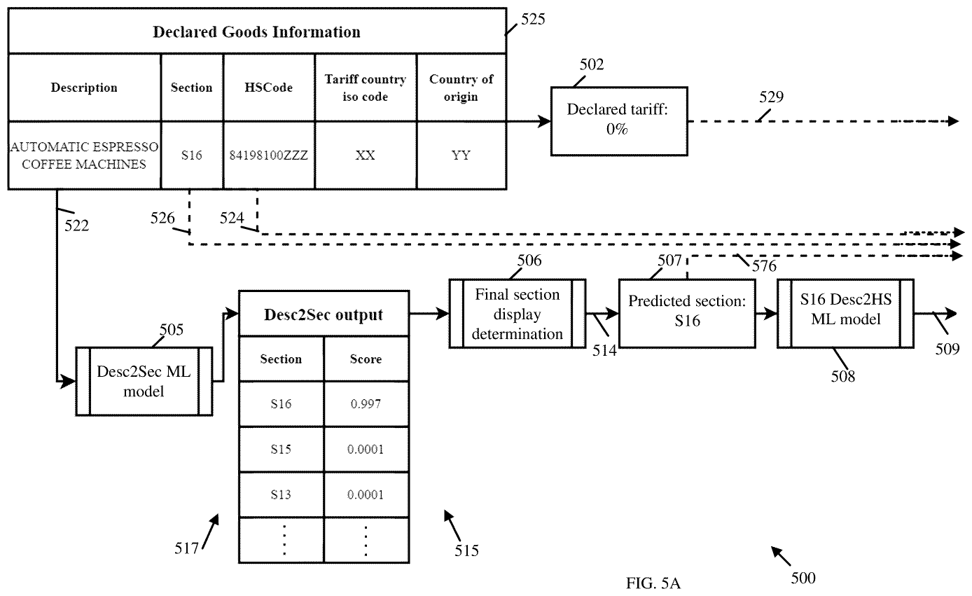

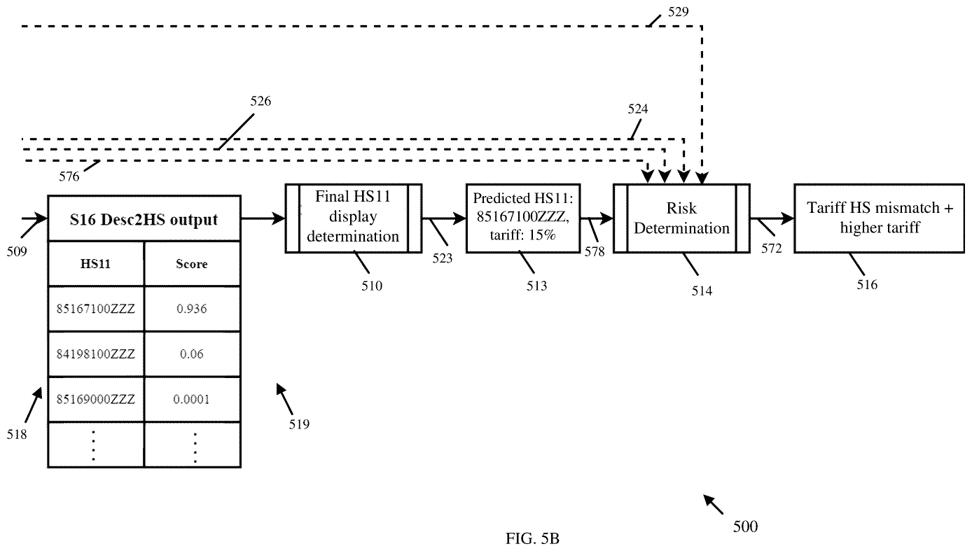

Reference is made to FIGS. 5A and 5B, which schematically illustrate a flow chart of a method 500 of providing vetting information based on declared goods information 525, in accordance with some demonstrative aspects. For example, one or more of the operations of the method of FIGS. 5A and 5B may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, as shown in FIG. 5A, the declared goods information 525 may include a declared description 522 of goods of an imported shipment, e.g., including the description “AUTOMATIC ESPRESSO COFFEE MACHINES”.

In some demonstrative aspects, as shown in FIG. 5A, the declared goods information 525 may include a declared section code 526, e.g., including the declared section code “S16”.

In some demonstrative aspects, as shown in FIG. 5A, the declared goods information 525 may include a declared HS code 524, e.g., including the declared HS code “84198100ZZZ”.

In some demonstrative aspects, as shown in FIG. 5A, the declared goods information 525 may include a country code, e.g., a tariff country ISO code, and/or country-of-origin information corresponding to an exporter country of the imported shipment.

In some demonstrative aspects, as indicated at block 502, the method may include determining a declared tariff 529, e.g., 0%, for the goods, for example, based on the declared goods information 525. For example, application 160 (FIG. 1), e.g., back-end 164 (FIG. 1), may be configured to determine the declared tariff 529, e.g., 0%, for the goods based on the declared goods information 525.

In some demonstrative aspects, as indicated at block 504, the method may include determining a plurality of section-code scores 515 corresponding to a plurality of predefined section codes 517, for example, based on the declared description 522. For example, application 160 (FIG. 1), e.g., back-end 164 (FIG. 1), may be configured to determine the plurality of section-code scores 515 corresponding to the plurality of predefined section codes 517, for example, based on the declared description 522.

In one example, an ML engine may be configured to determine the plurality of section-code scores 515. For example, ML engine 135 (FIG. 1) may determine the plurality of section-code scores 515 corresponding to the plurality of predefined section codes 517, e.g., as described above.

In some demonstrative aspects, as indicated at block 506, the method may include determining one or more potential section codes 514, for example, based on the plurality of section-code scores 515 corresponding to the plurality of predefined section codes 517. For example, application 160 (FIG. 1), e.g., back-end 164 (FIG. 1), may be configured to determine the one or more potential section codes 514, for example, based on the plurality of section-code scores 515 corresponding to the plurality of predefined section codes 517, e.g., as described above.

In some demonstrative aspects, as indicated at block 507, the method may include determining a predicted section code 576, e.g., the section code “S16”, for example, based on the one or more potential section codes 514. For example, application 160 (FIG. 1), e.g., back-end 164 (FIG. 1), may be configured to determine the predicted section code 576, for example, based on the one or more potential section codes 514, e.g., as described above.

In one example, application 160 (FIG. 1), e.g., back-end 164 (FIG. 1), may be configured to determine the predicted section code 576, for example, based on a highest score of the plurality of section-code scores 515, e.g., as described above.

In one example, application 160 (FIG. 1), e.g., back-end 164 (FIG. 1), may be configured to determine that there is no mismatch between the predicted section code 576, e.g., the section code “S16”, and the declared section code 526, e.g., the section code “S16”.

In some demonstrative aspects, as indicated at block 508, the method may include determining a plurality of HS-code scores 519 corresponding to a plurality of predefined section-related HS codes 518, which may correspond to the predicted section code 576, e.g., to the section code “S16”, for example, based on the declared description 522 of the goods. For example, application 160 (FIG. 1), e.g., back-end 164 (FIG. 1), may be configured to determine the plurality of HS-code scores 519 corresponding to the plurality of predefined section-related HS codes 518, for example, based on the predicted section code 576 and the declared description 522 of the goods.

In some demonstrative aspects, as indicated at block 508, the method may include providing the plurality of HS-code scores 519 corresponding to the plurality of predefined section-related HS codes 518, for example, by an output 509 of an ML engine, e.g., as described above.

In one example, an ML engine may be configured to provide the output 509 including the plurality of HS-code scores 519 corresponding to the plurality of predefined section-related HS codes 518. For example, ML engine 145 (FIG. 1), which may correspond to the predicted section code 576, e.g., the section code “S16”, may be configured to determine the plurality of HS-code scores 519 corresponding to the plurality of predefined section-related HS codes 518, e.g., corresponding to the section code “S16”.

In some demonstrative aspects, as indicated at block 510, the method may include determining one or more potential section-related HS codes 523, corresponding to the predicted section code 576, e.g., the section code “S16”, for example, based on the plurality of HS-code scores 519 corresponding to the plurality of predefined section-related HS codes 518. For example, application 160 (FIG. 1), e.g., back-end 164 (FIG. 1), may be configured to determine the one or more potential section-related HS codes 523, for example, based on the plurality of HS-code scores 519 corresponding to the plurality of predefined section-related HS codes 518, e.g., as described above.

In some demonstrative aspects, as indicated at block 513, the method may include determining a predicted HS code 578, e.g., the predicted HS code “85167100ZZZ”, for example, based on the one or more potential section-related HS codes 523. For example, application 160 (FIG. 1), e.g., back-end 164 (FIG. 1), may be configured to determine the predicted HS code 578, e.g., the predicted HS code “85167100ZZZ”, for example, based on the one or more potential section-related HS codes 523, e.g., as described above.

In some demonstrative aspects, as indicated at block 513, the method may include determining a predicted tariff, e.g., 15%, corresponding to the predicted HS code 578. For example, application 160 (FIG. 1), e.g., back-end 164 (FIG. 1), may be configured to determine the predicted tariff, e.g., 15%, corresponding to the predicted HS code “85167100ZZZ”.

In some demonstrative aspects, as indicated at block 514, the method may include determining risk information 572, for example, based on the predicted section code 576, the predicted HS code 578, the declared section code 526, and the declared HS code 524. For example, application 160 (FIG. 1), e.g., back-end 164 (FIG. 1), may be configured to determine the risk information 172 (FIG. 1), for example, based on the predicted section code 576, the predicted HS code 578, the declared section code 526, and the declared HS code 524, e.g., as described above.

In some demonstrative aspects, as indicated at block 516, the method may include providing an output including vetting information including the risk information 572, for example, to indicate a tariff risk corresponding to a declaration fraud, for example, based on a mismatch between the declared tariff 529, e.g., 15%, for the declared HS code 525 and the predicted tariff, e.g., 0%, for the predicted HS code 578. For example, the declared tariff 529, e.g., 15%, may be higher than the predicted tariff, e.g., 0%, which may indicate a declaration fraud, for example, to reduce the tariff for the goods.

For example, application 160 (FIG. 1), e.g., back-end 164 (FIG. 1), may be configured to provide the output including the vetting information 167 (FIG. 1) including the risk information 572 (FIG. 1), which may be configured, for example, to indicate the tariff risk based on the mismatch between the declared tariff 529, e.g., 0%, for the declared HS code 524 and the predicted tariff, e.g., 15%, for the predicted HS code 478.

In some demonstrative aspects, application 160 (FIG. 1), e.g., back-end 162 (FIG. 1), may be configured to cause GUI 116 (FIG. 1) to present to a user the tariff risk corresponding, for example, to the mismatch between the declared tariff 529, e.g., 15%, for the declared HS code 525 and the predicted tariff, e.g., 0%, for the predicted HS code 578.

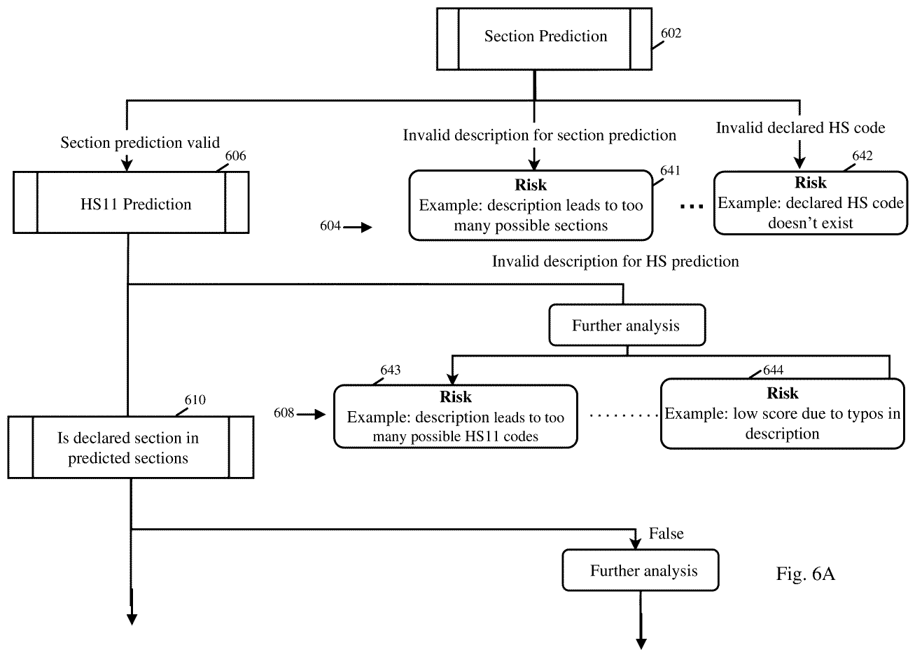

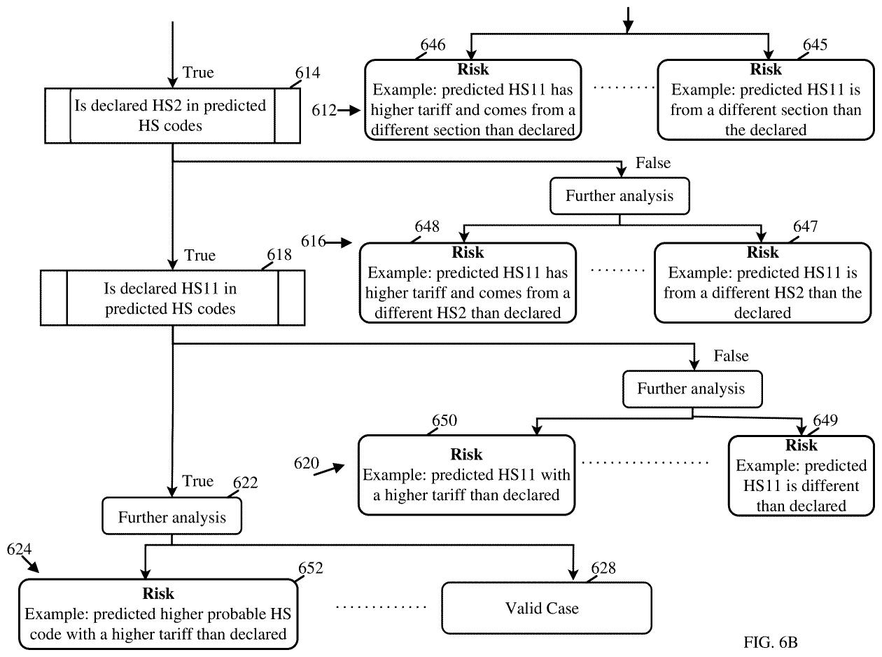

Reference is made to FIGS. 6A and 6B, which schematically illustrate a flow chart of a method 600 of determining risk information for goods of an imported shipment based on declared goods information, in accordance with some demonstrative aspects. For example, one or more of the operations of the method of FIGS. 6 and 6B may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, the declared goods information may include a declared description of the goods, a declared section code for the goods, a declared HS code for the goods, and/or a declared tariff for the goods, e.g., as described above.

In some demonstrative aspects, as indicated at block 602, the method may include determining whether or not the declared goods information is definite, for example, by determining whether or not the declared goods information is sufficient for a section analysis of the goods. For example, application 160 (FIG. 1), e.g., back-end 164 (FIG. 1), may be configured to preprocess the declared goods information 125 (FIG. 1), for example, to determine whether or not the declared goods information 125 (FIG. 1) is definite for the purpose of the section analysis of the goods, e.g., as described above.

In some demonstrative aspects, as indicated at blocks 604, the method may include determining one or more indefinite-declared-description risks corresponding to the section analysis of the goods, for example, based on a determination that the declared goods information is not specific enough for the section analysis of the goods. For example, application 160 (FIG. 1), e.g., back-end 164 (FIG. 1), may be configured to determine the one or more indefinite-declared-description risks corresponding to the section analysis of the goods, for example, based on the determination that the declared goods information 125 (FIG. 1) is not specific enough for the section analysis of the goods, e.g., as described above.

In one example, an indefinite-declared-description risk 641 may include an indication that the declared description of the goods may lead to too many potential section codes.

In another example, an indefinite-declared-description risk 642 may include an indication that the declared section code for the goods, and/or the declared HS-code for the goods, do not exist, e.g., in the HS.

In other aspects, application 160 (FIG. 1), e.g., back-end 164 (FIG. 1), may be configured to determine any other additional and/or alternative indefinite-declared-description risks corresponding to the section analysis of the goods.

In some demonstrative aspects, application 160 (FIG. 1), e.g., front-end 162 (FIG. 1), may be configured to cause GUI 116 (FIG. 1) to present the one or more indefinite-declared-description risks corresponding to the section analysis of the goods to the user, e.g., as described above.

In some demonstrative aspects, as indicated at block 606, the method may include determining whether or not the declared goods information is definite for HS-code analysis of the goods, for example, based on a determination that the declared goods information 125 (FIG. 1) is specific enough for the section analysis of the goods. For example, application 160 (FIG. 1), e.g., back-end 164 (FIG. 1), may be configured to preprocess the declared goods information 125 (FIG. 1), for example, to determine whether or not the declared goods information 125 (FIG. 1) is definite for the HS-code analysis of the goods, e.g., as described above.

In some demonstrative aspects, as indicated at blocks 608, the method may include determining one or more indefinite-declared-description risks corresponding to the HS-code analysis of the goods, for example, based on a determination that the declared goods information is not specific enough for the HS-code analysis of the goods. For example, application 160 (FIG. 1), e.g., back-end 164 (FIG. 1), may be configured to determine the one or more indefinite-declared-description risks corresponding to the HS-code analysis of the goods, for example, based on the determination that the declared goods information 125 (FIG. 1) is not specific enough for the HS-code analysis of the goods, e.g., as described above.

In one example, an indefinite-declared-description risk 643 may include an indication that the declared description of the goods leads to too many potential HS codes.

In another example, an indefinite-declared-description risk 644 may include an indication that the HS-code analysis of the goods may not be accurate, for example, due to one or more typos in the declared description of the goods, e.g., as described above.

In other aspects, application 160 (FIG. 1), e.g., back-end 164 (FIG. 1), may be configured to determine any other additional and/or alternative indefinite-declared-description risks corresponding to the HS-code analysis of the goods.

In some demonstrative aspects, application 160 (FIG. 1), e.g., front-end 162 (FIG. 1), may be configured to cause GUI 116 (FIG. 1) to present the one or more indefinite-declared-description risks corresponding to the HS-code analysis of the goods to the user, e.g., as described above.

In some demonstrative aspects, as indicated at block 610, the method may include determining whether or not the declared section code is in one or more potential section codes, for example, based on a determination that the declared goods information 125 (FIG. 1) is specific enough for the section-code analysis and the HS-code analysis. For example, application 160 (FIG. 1), e.g., back-end 164 (FIG. 1), may be configured to determine whether or not the declared section code 126 (FIG. 1) is in the one or more potential section codes 138 (FIG. 1), e.g., as described above.

In some demonstrative aspects, as indicated at blocks 612, the method may include determining one or more section-code-mismatch risks, for example, based on a mismatch between the declared section code and the one or more potential section codes. For example, application 160 (FIG. 1), e.g., back-end 164 (FIG. 1), may be configured to determine a section-code-mismatch risk, for example, based on the mismatch between the declared section code 126 (FIG. 1) and the predicted section code 176 (FIG. 1), e.g., as described above.

In one example, a section-code-mismatch risk 645 may include an indication that the predicted HS code corresponds to a predicted section code different from the declared section code.

In another example, a section-code-mismatch risk 646 may include an indication that the predicted HS code corresponds to a predicted section code different from the declared section code, and that the predicted HS code has higher tariff than the declared tariff for the declared HS code.

In other aspects, application 160 (FIG. 1), e.g., back-end 164 (FIG. 1), may be configured to determine any other additional and/or alternative section-code-mismatch risks.

In some demonstrative aspects, application 160 (FIG. 1), e.g., front-end 162 (FIG. 1), may be configured to cause GUI 116 (FIG. 1) to present the one or more section-code-mismatch risks to the user, e.g., as described above.

In some demonstrative aspects, as indicated at block 614, the method may include determining whether or not a declared header code of the declared HS code matches a header code of a potential HS code of the one or more potential HS codes, for example, based on a determination that the declared section code is in the one or more potential section codes. For example, application 160 (FIG. 1), e.g., back-end 164 (FIG. 1), may be configured to determine whether or not the header of the declared HS code 124 (FIG. 1) matches a header of the one or more potential section-related HS codes 148 (FIG. 1), e.g., as described above.

In some demonstrative aspects, as indicated at blocks 616, the method may include determining one or more HS2-code-mismatch risks, for example, based on a mismatch between the header code of the declared HS code and header codes of the one or more potential HS codes. For example, application 160 (FIG. 1), e.g., back-end 164 (FIG. 1), may be configured to determine one or more HS2-code-mismatch risks based on the mismatch between the header code of the declared HS code 124 (FIG. 1) and the header codes of the one or more potential section-related HS codes 148 (FIG. 1), e.g., as described above.

In one example, an HS2-code-mismatch risk 647 may include an indication that a predicted header code of the predicted HS code is different from a declared header code of the declared HS code.

In another example, an HS2-code-mismatch risk 648 may include an indication that the header code of the predicted HS code is different from the HS2 header code of the declared HS code, and a predicted tariff for the predicted HS code is higher than the declared tariff for the declared HS-code.

In other aspects, application 160 (FIG. 1), e.g., back-end 164 (FIG. 1), may be configured to determine any other additional and/or alternative HS2-code-mismatch risks.

In some demonstrative aspects, application 160 (FIG. 1), e.g., front-end 162 (FIG. 1), may be configured to cause GUI 116 (FIG. 1) to present the one or more HS2-code-mismatch risks to the user, e.g., as described above.

In some demonstrative aspects, as indicated at block 618, the method may include determining whether or not the declared HS code matches an HS code of the or more potential HS codes, for example, based on a determination that the header code of the declared HS code matches the header code of the potential HS-code. For example, application 160 (FIG. 1), e.g., back-end 164 (FIG. 1), may be configured to determine whether or not the declared HS code 124 (FIG. 1) matches a potential section-related HS code 148 (FIG. 1) of the one or more potential section-related HS codes 148 (FIG. 1), e.g., as described above.

In some demonstrative aspects, as indicated at blocks 620, the method may include determining one or more HS-code-mismatch risks, for example, based on a mismatch between the declared HS code and the one or more potential HS codes. For example, application 160 (FIG. 1), e.g., back-end 164 (FIG. 1), may be configured to determine one or more HS-code-mismatch risks, for example, based on the mismatch between the declared HS code 124 (FIG. 1) and the one or more potential section-related HS codes 148 (FIG. 1), e.g., as described above.

In one example, an HS-code-mismatch risk 649 may include an indication that the predicted HS code is different from the declared HS code.

In another example, an HS-code-mismatch risk 650 may include an indication that the predicted HS code is different from the declared HS code, and the predicted tariff of the predicted HS code is higher than the declared tariff for the declared HS-code.

In other aspects, application 160 (FIG. 1), e.g., back-end 164 (FIG. 1), may be configured to determine any other additional and/or alternative HS-code-mismatch risks.

In some demonstrative aspects, application 160 (FIG. 1), e.g., front-end 162 (FIG. 1), may be configured to cause GUI 116 (FIG. 1) to present the one or more HS-code-mismatch risks to the user, e.g., as described above.

In some demonstrative aspects, as indicated at block 622, the method may include performing further analysis to determine whether or not the declared goods information is valid, for example, based on a determination that the declared HS code matches the predicted HS code. For example, application 160 (FIG. 1), e.g., back-end 164 (FIG. 1), may be configured to determine whether or not the declared goods information 125 (FIG. 1) is valid.

In some demonstrative aspects, as indicated at blocks 624, the method may include determining one or more tariff-mismatch risks, for example, based on a mismatch between the declared tariff for the declared HS code and the predicted tariff for the predicted HS code. For example, application 160 (FIG. 1), e.g., back-end 164 (FIG. 1), may be configured to determine the one or more tariff-mismatch risks, for example, based on the mismatch between the declared tariff 129 (FIG. 1) for the declared HS code 124 (FIG. 1) and the predicted tariff 179 (FIG. 1) for the predicted HS code 178 (FIG. 1), e.g., as described above.

In one example, a tariff-mismatch risk 652 may include an indication that the predicted tariff of the predicted HS code is higher than the declared tariff for the declared HS-code, for example, even though the declared HS code matches the predicted HS code.

In other aspects, application 160 (FIG. 1), e.g., back-end 164 (FIG. 1), may be configured to determine any other additional and/or alternative tariff-mismatch risks.

In some demonstrative aspects, application 160 (FIG. 1), e.g., front-end 162 (FIG. 1), may be configured to cause GUI 116 (FIG. 1) to present the one or more tariff-mismatch risks to the user, e.g., as described above.

In some demonstrative aspects, as indicated at block 628, the method may include determining that the declared goods information is valid, for example, based on a determination that no risk was found. For example, application 160 (FIG. 1), e.g., back-end 164 (FIG. 1), may be configured to determine that the declared goods information 125 (FIG. 1) is valid, for example, based on the determination that no risk was found.

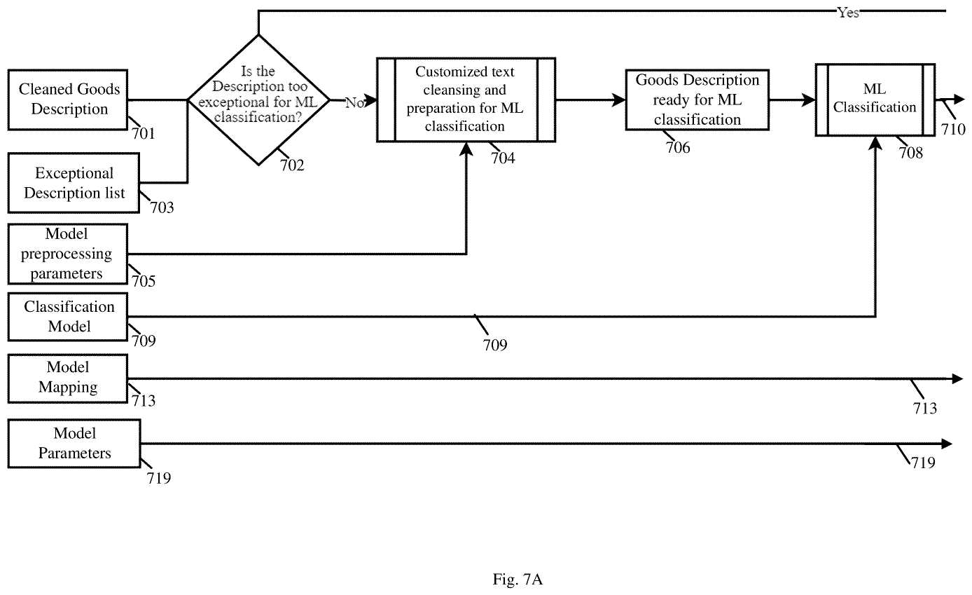

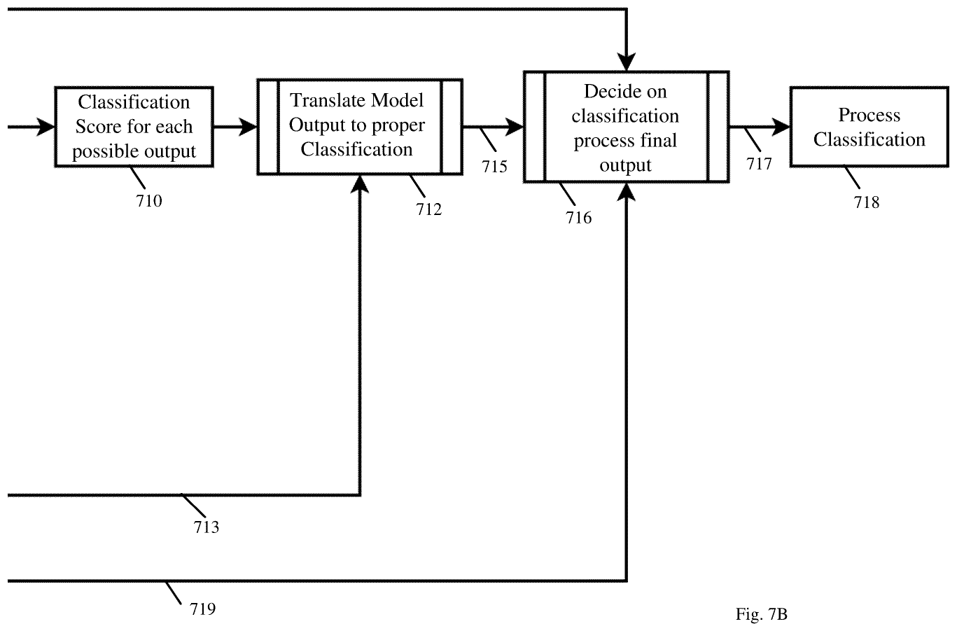

Reference is made to FIGS. 7A and 7B, which schematically illustrate a flow chart of a method 700 of determining one or more classification codes for goods of an imported shipment, in accordance with some demonstrative aspects. For example, one or more of the operations of the method of FIGS. 7A and 7B may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

In some demonstrative aspects, one or more, e.g., some or all, operations of the method 700 may be implemented, for example, to determine the one or more potential section codes 138 (FIG. 1).

For example, one or more, e.g., some or all, operations of the method 700 may be implemented, for example, to determine the one or more potential section codes 314 (FIG. 3); to determine the one or more potential section codes 414 (FIG. 4), and/or to determine the one or more potential section codes 514 (FIG. 5).

In some demonstrative aspects, one or more, e.g., some or all, operations of the method 700 may be implemented, for example, by a first ML engine. For example, ML engine 135 (FIG. 1) may implement one or more, e.g., some or all, operations of the method 700.

In some demonstrative aspects, one or more, e.g., some or all, operations of the method 700 may be implemented, for example, to determine the one or more potential section-related HS codes 148 (FIG. 1).

For example, one or more, e.g., some or all, operations of the method 700 may be implemented, for example, to determine the one or more potential section-related HS codes 323 (FIG. 3); to determine the one or more potential section-related HS codes 423 (FIG. 4), and/or to determine the one or more potential section-related HS codes 523 (FIG. 5).

In some demonstrative aspects, one or more, e.g., some or all, operations of the method 700 may be implemented, for example, by a second ML engine. For example, ML engine 145 (FIG. 1) may implement one or more, e.g., some or all, operations of the method 700.

In some demonstrative aspects, as indicated at block 702, the method may include determining whether or not declared goods information of the goods is definite, for example, by determining whether or not the declared goods information of the goods is sufficient to allow classifying the goods. For example, application 160 (FIG. 1), e.g., back-end 164 (FIG. 1), may be configured to determine whether or not the declared goods information 125 (FIG. 1) is definite, e.g., as described above.

In some demonstrative aspects, as indicated at block 701, determining whether or not the declared goods information is definite may include determining whether or not the declared goods information is definite, for example, based on a cleaned description of the goods.

In some demonstrative aspects, as indicated at block 703, determining whether or not the declared description of the goods is indefinite, may include, determining whether or not the declared description of the goods is indefinite, for example, based on one or more predefined descriptions. For example, the one or more predefined descriptions may be defined according to a list of exceptional descriptions, which may not allow to classify the goods.

In some demonstrative aspects, as indicated at block 704, the method may include preprocessing the declared description of the goods to determine a preprocessed description 706 of the goods. For example, the preprocessed description 706 of the goods may be configured according to a predefined input format. For example, the input format may be configured for the classification of the goods. For example, the input format may include an input format of an ML engine to process the preprocessed description 706 of the goods.

For example, application 160 (FIG. 1), e.g., back-end 164 (FIG. 1), may be configured to preprocess the declared description 122 (FIG. 1) of the goods to determine the preprocessed description 152 (FIG. 1) of the goods, which may be configured according to the predefined input format of the ML input 132 (FIG. 1) of ML engine 135 (FIG. 1), e.g., as described above.

For example, application 160 (FIG. 1), e.g., back-end 164 (FIG. 1), may be configured to preprocess the declared description 122 (FIG. 1) of the goods to determine the preprocessed description 152 (FIG. 1) of the goods, which may be configured according to the predefined input format of the ML input 142 (FIG. 1) of ML engine 145 (FIG. 1), e.g., as described above.

In some demonstrative aspects, as indicated at block 705, preprocessing the declared description of the goods may include preprocessing the declared description of the goods, for example, based on one or more model preprocessing parameters, e.g., corresponding to the ML engine to process the preprocessed description 706 of the goods.

In one example, the one or more model preprocessing parameters may include language-based preprocessing parameters, which may be configured, for example, to modify a language of the declared description according to a language of an importer country.

In another example, the one or more model preprocessing parameters may include one or more text structures, which may be configured, for example, to modify one or more text structures of the declared description of the goods.

In another example, the one or more model preprocessing parameters may include one or more cleansing parameters, which may be configured, for example, to cleanse or modify one or more words in the declared description of the goods.

In other aspects, the one or more model preprocessing parameters may include any other additional and/or alternative parameters, which may be configured, according to any other preprocessing operations and/or any other parameter corresponding to the ML engine to process the preprocessed description 706 of the goods.

In some demonstrative aspects, as indicated at block 708, the method may include classifying the goods, for example, by determining a plurality of classification scores 710 for a plurality of predefined classification codes, e.g., for each classification code, for example, based on the preprocessed description 706 of the goods.

For example, application 160 (FIG. 1), e.g., back-end 164 (FIG. 1), may be configured to determine the plurality of section-code scores 315 (FIG. 3) corresponding to the plurality of predefined section codes 317 (FIG. 3), for example, based on the preprocessed description 706 corresponding to the declared description 322 (FIG. 3) of goods.

For example, application 160 (FIG. 1), e.g., back-end 164 (FIG. 1), may be configured to determine the plurality of section-code scores 415 (FIG. 4) corresponding to the plurality of predefined section codes 417 (FIG. 4), for example, based on the preprocessed description 706 corresponding to the declared description 422 (FIG. 4) of goods, e.g., as described above.

For example, application 160 (FIG. 1), e.g., back-end 164 (FIG. 1), may be configured to determine the plurality of section-code scores 515 (FIG. 5) corresponding to the plurality of predefined section codes 517 (FIG. 5), for example, based on the preprocessed description 706 corresponding to the declared description 522 (FIG. 5) of goods, e.g., as described above.

For example, application 160 (FIG. 1), e.g., back-end 164 (FIG. 1), may be configured to determine the plurality of HS-code scores 319 (FIG. 3) corresponding to the plurality of predefined section-related HS codes 318 (FIG. 3), for example, based on the preprocessed description 706 corresponding to the declared description 322 (FIG. 3) of goods, e.g., as described above.

For example, application 160 (FIG. 1), e.g., back-end 164 (FIG. 1), may be configured to determine the plurality of HS-code scores 419 (FIG. 4) corresponding to the plurality of predefined section-related HS codes 418 (FIG. 4), for example, based on the preprocessed description 706 corresponding to the declared description 422 (FIG. 4) of goods, e.g., as described above.

For example, application 160 (FIG. 1), e.g., back-end 164 (FIG. 1), may be configured to determine the plurality of HS-code scores 519 (FIG. 5) corresponding to the plurality of predefined section-related HS codes 518 (FIG. 5), for example, based on the preprocessed description 706 corresponding to the declared description 522 (FIG. 5) of goods, e.g., as described above.

In some demonstrative aspects, as indicated at block 709, classifying the goods may include determining the plurality of classification scores 710 for the plurality of predefined classification codes, for example, based on a classification model, for example, a LLM model and/or any other additional or alternative suitable model, e.g., as described above.

For example, classifying the goods may include determining the plurality of classification scores 710 for the plurality of predefined classification codes, for example, based on an output of a first ML engine, e.g., ML engine 135 (FIG. 1), e.g., as described above.

For example, classifying the goods may include determining the plurality of classification scores 710 for the plurality of predefined classification codes, for example, based on an output of a second ML engine, e.g., ML engine 145 (FIG. 1), e.g., as described above.

In some demonstrative aspects, as indicated at block 712, the method may include determining one or more potential classification codes 715, for example, based on the plurality of classification scores 710.

For example, application 160 (FIG. 1), e.g., back-end 164 (FIG. 1), may be configured to determine the one or more potential section codes 138 (FIG. 1), for example, based on the plurality of classification scores 710, which may include a plurality of section-code scores, e.g., as described above.

For example, application 160 (FIG. 1), e.g., back-end 164 (FIG. 1), may be configured to determine the one or more potential section-related HS codes 148 (FIG. 1), for example, based on the plurality of classification scores 710, which may include a plurality of HS-code scores corresponding to a plurality of predefined section-related HS codes, which correspond to the potential section code, e.g., as described above.

In some demonstrative aspects, as indicated at block 713, determining the one or more potential classification codes 715 may include determining the one or more potential classification codes 715, for example, based on a model score mapping, for example, which may be configured to map, for example, one or more scores of the plurality of classification scores to the one or more potential classification codes 715.

In one example, the model score mapping may be configured to map, for example, one or more highest scores of the plurality of classification scores to the one or more potential classification codes 715, e.g., as described above. In other aspects, the model score mapping may be configured to map one or more scores of the plurality of classification scores to the one or more potential classification codes 715 according to any other suitable additional or alternative score mapping criteria.

In some demonstrative aspects, as indicated at block 716, the method may include determining a predicted classification code 717, for example, based on the one or more potential classification codes 715.

For example, application 160 (FIG. 1), e.g., back-end 164 (FIG. 1), may be configured to determine the predicted classification code 717, which may include the predicted section code 176 (FIG. 1), for example, based on the one or more potential classification codes 715, which may include the one or more potential section codes 138 (FIG. 1), e.g., as described above.

For example, application 160 (FIG. 1), e.g., back-end 164 (FIG. 1), may be configured to determine the predicted classification code 717, which may include the predicted HS code 178 (FIG. 1), for example, based on the one or more potential classification codes 715, which may include the one or more potential section-related HS codes 148 (FIG. 1), e.g., as described above.

In some demonstrative aspects, as indicated at block 719, determining the predicted classification code 717 may include determining the predicted classification code 717, for example, based on one or more model parameters, e.g., a highest score parameter and/or the like.

In some demonstrative aspects, as indicated at block 718, the method may include processing the predicted classification code 717, for example, to determine risk information corresponding to a declaration fraud of the goods, e.g., as described above.

For example, application 160 (FIG. 1), e.g., back-end 164 (FIG. 1), may be configured to determine the risk information 172 (FIG. 1) to indicate one or more risks corresponding to a declaration fraud, for example, based on a mismatch between the declared HS code 124 (FIG. 1) and the predicted classification code 717, which may be determined to include the predicted HS code 178 (FIG. 1), e.g., as described below.

For example, application 160 (FIG. 1), e.g., back-end 164 (FIG. 1), may be configured to determine the risk information 172 (FIG. 1) to indicate one or more risks corresponding to a declaration fraud, for example, based on a mismatch between the declared section code 126 (FIG. 1) and the predicted classification code 717, which may be determined to include the predicted section code 176 (FIG. 1), e.g., as described below.

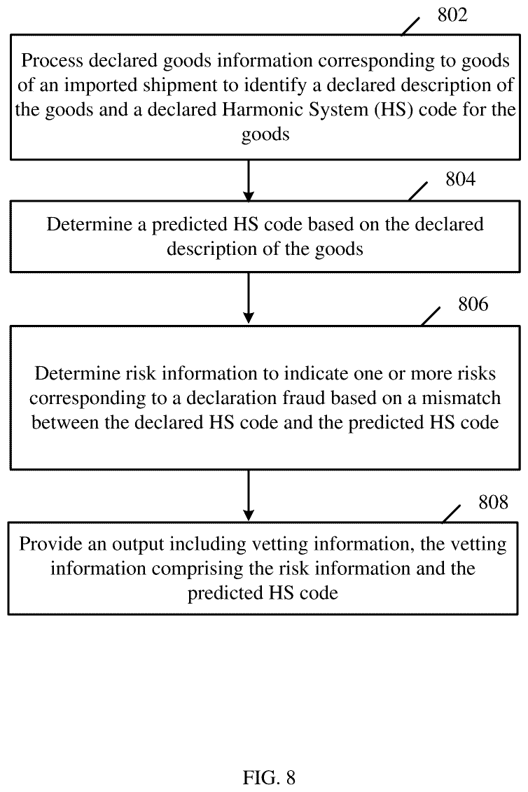

Reference is made to FIG. 8, which schematically illustrates a method of providing vetting information, in accordance with some demonstrative aspects. For example, one or more of the operations of the method of FIG. 8 may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), a back-end, e.g., back-end 164 (FIG. 1), and/or a front-end, e.g., front-end 162 (FIG. 1).

As indicated at block 802, the method may include processing declared goods information corresponding to goods of an imported shipment, for example, to identify a declared description of the goods and a declared HS code for the goods. For example, application 160 (FIG. 1) may process the declared goods information 125 (FIG. 1) corresponding to the goods of the imported shipment, for example, to identify the declared description 122 (FIG. 1) of the goods and the declared HS code 124 (FIG. 1) for the goods, e.g., as described above.

As indicated at block 804, the method may include determining a predicted HS code, for example, based on the declared description of the goods. For example, application 160 (FIG. 1) may determine the predicted HS code 178 (FIG. 1), for example, based on the declared description 122 (FIG. 1) of the goods, e.g., as described above.

As indicated at block 806, the method may include determining risk information to indicate one or more risks corresponding to a declaration fraud based on a mismatch between the declared HS code and the predicted HS code. For example, application 160 (FIG. 1) may determine the risk information 172 (FIG. 1) to indicate the one or more risks corresponding to the declaration fraud based on the mismatch between the declared HS code 124 (FIG. 1) and the predicted HS code 178 (FIG. 1), e.g., as described above.

As indicated at block 808, the method may include providing an output including vetting information. For example, the vetting information may include the risk information and the predicted HS code. For example, application 160 (FIG. 1) may provide the output, e.g., via GUI 116 (FIG. 1), including the vetting information 167 (FIG. 1) including the risk information 172 (FIG. 1) and the predicted HS code 178 (FIG. 1), e.g., as described above.

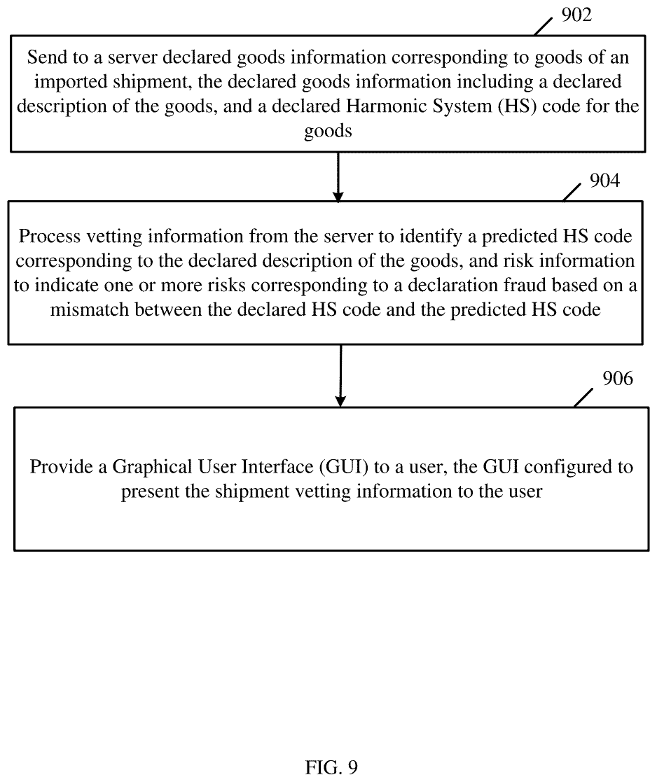

Reference is made to FIG. 9, which schematically illustrates a method of presenting shipment vetting information to a user, in accordance with some demonstrative aspects. For example, one or more of the operations of the method of FIG. 9 may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), and/or a front-end, e.g., front-end 162 (FIG. 1).

As indicated at block 902, the method may include sending to a server declared goods information corresponding to goods of an imported shipment. For example, the declared goods information may include a declared description of the goods, and a declared HS code for the goods, For example, front-end 162 (FIG. 1) may send to server 170 (FIG. 1) the declared goods information 125 (FIG. 1) corresponding to the goods of the imported shipment, e.g., as described above.

As indicated at block 904, the method may include processing vetting information from the server to identify a predicted HS code corresponding to the declared description of the goods, and risk information to indicate one or more risks corresponding to a declaration fraud based on a mismatch between the declared HS code and the predicted HS code. For example, front-end 162 (FIG. 1) may process the vetting information 167 (FIG. 1) from the server 170 (FIG. 1) to identify the predicted HS code 178 (FIG. 1) corresponding to the declared description 122 (FIG. 1) of the goods, and the risk information 172 (FIG. 1) to indicate the one or more risks corresponding to the declaration fraud based on the mismatch between the declared HS code 124 (FIG. 1) and the predicted HS code 178 (FIG. 1), e.g., as described above.

As indicated at block 906, the method may include providing a GUI to a user, the GUI configured to present the vetting information to the user. For example, front-end 162 (FIG. 1) may configure the GUI 116 (FIG. 1) to present the vetting information 167 (FIG. 1) to the user, e.g., as described above.

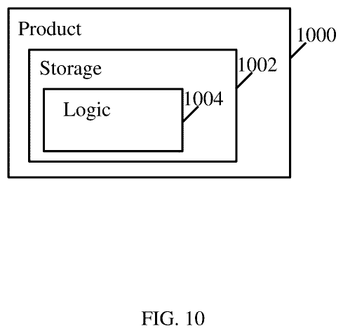

Reference is made to FIG. 10, which schematically illustrates a product of manufacture 1000, in accordance with some demonstrative aspects. Product 1000 may include one or more tangible computer-readable non-transitory storage media 1002, which may include computer-executable instructions, e.g., implemented by logic 1004, operable to, when executed by at least one computer processor, enable the at least one computer processor to implement one or more operations of computing device 102 (FIG. 1), server 170 (FIG. 1), application 160 (FIG. 1), front-end 162 (FIG. 1), and/or back-end 162 (FIG. 1), to perform one or more operations, and/or to perform, trigger and/or implement one or more operations, communications and/or functionalities according to one or more of the FIGS. 1-9, and/or one or more operations described herein. The phrase “non-transitory machine-readable medium” is directed to include all computer-readable media, with the sole exception being a transitory propagating signal.

In some demonstrative aspects, product 1000 and/or machine readable storage media 1002 may include one or more types of computer-readable storage media capable of storing data, including volatile memory, non-volatile memory, removable or non-removable memory, erasable or non-erasable memory, writeable or re-writeable memory, and the like. For example, machine readable storage media 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.
Example 1 includes a product comprising one or more tangible computer-readable non-transitory storage media comprising instructions operable to, when executed by at least one processor, enable the at least one processor to cause a computing system to process declared goods information corresponding to goods of an imported shipment to identify a declared description of the goods and a declared Harmonic System (HS) code for the goods; determine a predicted HS code based on the declared description of the goods; determine risk information to indicate one or more risks corresponding to a declaration fraud based on a mismatch between the declared HS code and the predicted HS code; and provide an output comprising vetting information, the vetting information comprising the risk information and the predicted HS code.
Example 2 includes the subject matter of Example 1, and optionally, wherein the instructions, when executed, cause the computing system to process the declared goods information to identify a declared section code for the goods; determine one or more potential section codes based on the declared description of the goods; and determine the risk information based on the one or more potential section codes and the declared section code.
Example 3 includes the subject matter of Example 2, and optionally, wherein the instructions, when executed, cause the computing system to determine a plurality of section-code scores corresponding to a plurality of predefined section codes, a section-code score corresponding to a predefined section code based on a correlation between the declared description of the goods and the predefined section code; and select the one or more potential section codes from the plurality of predefined section codes based on the plurality of section-code scores.
Example 4 includes the subject matter of Example 3, and optionally, wherein the instructions, when executed, cause the computing system to select the one or more potential section codes based on a comparison between the plurality of section-code scores and a predefined section-code threshold.
Example 5 includes the subject matter of Example 3 or 4, and optionally, wherein the instructions, when executed, cause the computing system to determine the plurality of section-code scores based on a Machine Learning (ML) output of a ML engine trained to generate the ML output based on an ML input, wherein the ML input is based on the declared description of the goods.
Example 6 includes the subject matter of Example 5, and optionally, wherein the ML output comprises the plurality of section-code scores corresponding to the plurality of predefined section codes.
Example 7 includes the subject matter of Example 5 or 6, and optionally, wherein the instructions, when executed, cause the computing system to preprocess the declared description of the goods to determine a preprocessed description of the goods configured according to a predefined input format of the ML input; and provide the preprocessed description of the goods as the ML input to the ML engine.
Example 8 includes the subject matter of any one of Examples 5-7, and optionally, wherein the ML engine comprises a Large Language Model (LLM) ML engine.
Example 9 includes the subject matter of any one of Examples 2-8, and optionally, wherein the instructions, when executed, cause the computing system to determine one or more potential section-related HS codes based on the one or more potential section codes and the declared description of the goods; and determine the predicted HS code based on the one or more potential section-related HS codes.
Example 10 includes the subject matter of Example 9, and optionally, wherein the instructions, when executed, cause the computing system to determine a plurality of HS-code scores corresponding to one or more pluralities of predefined section-related HS codes, the one or more pluralities of predefined section-related HS codes corresponding to the one or more potential section codes, wherein an HS-code score corresponding to a predefined section-related HS code that corresponds to a potential section code is based on a correlation between the declared description of the goods and the predefined section-related HS code corresponding to the potential section code; and determine the predicted HS code based on the plurality of HS-code scores.
Example 11 includes the subject matter of Example 10, and optionally, wherein the instructions, when executed, cause the computing system to determine the predicted HS code based on a highest score of the plurality of HS-code scores.
Example 12 includes the subject matter of Example 10 or 11, and optionally, wherein the instructions, when executed, cause the computing system to determine the plurality of HS-code scores corresponding to the one or more pluralities of predefined section-related HS codes based on one or more Machine Learning (ML) outputs of one or more ML engines corresponding to the one or more potential section codes, an ML engine corresponding to a potential section code trained to generate an ML output corresponding to the potential section code based on an ML input, the ML input based on the declared description of the goods.
Example 13 includes the subject matter of Example 12, and optionally, wherein the ML output corresponding to the potential section code comprises a plurality of HS-code scores corresponding to a plurality of predefined section-related HS codes corresponding to the potential section code.
Example 14 includes the subject matter of Example 12 or 13, and optionally, wherein the instructions, when executed, cause the computing system to select the one or more ML engines from a plurality of ML engines based on the one or more potential section codes, the plurality of ML engines corresponding to a plurality of predefined section codes.
Example 15 includes the subject matter of any one of Examples 12-14, and optionally, wherein the instructions, when executed, cause the computing system to, based on a determination of one or more first potential section codes, select a first set of one or more first ML engines from the plurality of ML engines and determine a first predicted HS code based on ML outputs of the one or more first ML engines; and based on a determination of one or more second potential section codes, select a second set of one or more second ML engines from the plurality of ML engines and determine a second predicted HS code based on ML outputs of the one or more second ML engines, wherein the one or more second potential section codes are different from the one or more first potential section codes, and the first set of one or more second ML engines is different from the second set of one or more first ML engines.
Example 16 includes the subject matter of any one of Examples 12-15, and optionally, wherein the instructions, when executed, cause the computing system to preprocess the declared description of the goods to determine a preprocessed description of the goods configured according to a predefined input format of the ML input; and provide the preprocessed description of the goods as the one or more ML inputs to the one or more ML engines.
Example 17 includes the subject matter of any one of Examples 12-16, and optionally, wherein the ML engine comprises a Large Language Model (LLM) ML engine.
Example 18 includes the subject matter of any one of Examples 2-17, and optionally, wherein the instructions, when executed, cause the computing system to determine a predicted section code based on the one or more potential section codes; and determine the risk information based on a section mismatch between the declared section code and the predicted section code.
Example 19 includes the subject matter of Example 18, and optionally, wherein the instructions, when executed, cause the computing system to determine the predicted section code based on the predicted HS code.
Example 20 includes the subject matter of Example 18 or 19, and optionally, wherein the risk information comprises section-code-mismatch information to indicate a section-code-mismatch risk based on the mismatch between the declared section code and the predicted section code.
Example 21 includes the subject matter of any one of Examples 18-20, and optionally, wherein the vetting information comprises the predicted section code.
Example 22 includes the subject matter of any one of Examples 1-21, and optionally, wherein the instructions, when executed, cause the computing system to determine the risk information comprising an indication that the declared description of the goods is indefinite, based on a determination that the declared description of the goods is not specific enough to determine the predicted HS code.
Example 23 includes the subject matter of any one of Examples 1-22, and optionally, wherein the instructions, when executed, cause the computing system to preprocess the declared description of the goods to determine a preprocessed description of the goods configured according to a predefined input format, which is configured for determination of the predicted HS code; and determine the predicted HS code based on the preprocessed description of the goods.
Example 24 includes the subject matter of Example 23, and optionally, wherein the preprocessing of the declared description comprises at least one of a language preprocessing to modify a language of the declared description according to a language of an importer country, a text preprocessing to modify one or more text structures of the declared description, or a cleansing preprocessing to clean words in the declared description.
Example 25 includes the subject matter of any one of Examples 1-24, and optionally, wherein the instructions, when executed, cause the computing system to determine a first predicted HS code based on a first declared description of the goods; and determine a second predicted HS code based on a second declared description of the goods, wherein the second predicted HS code is different from the first predicted HS code, and the second declared description is different from the first declared description.
Example 26 includes the subject matter of any one of Examples 1-25, and optionally, wherein the declared goods information comprises at least one of a declared section code for the goods, tariff information corresponding to a declared tariff for the goods, or country-of-origin information corresponding to a country of origin of the imported shipment, wherein the instructions, when executed, cause the computing system to determine the risk information based on at least one of the declared section code for the goods, the tariff information, or the country-of-origin information.
Example 27 includes the subject matter of any one of Examples 1-26, and optionally, wherein the risk information comprises tariff-mismatch information to indicate a tariff risk based on a mismatch between a first tariff for the declared HS code and a second tariff for the predicted HS code.
Example 28 includes the subject matter of any one of Examples 1-27, and optionally, wherein the risk information comprises regulatory-risk information to indicate a regulatory risk based on a mismatch between first regulations for the declared HS code and second regulations for the predicted HS code.
Example 29 includes the subject matter of any one of Examples 1-28, and optionally, wherein the risk information comprises HS-code-mismatch information to indicate an HS-code-mismatch risk based on the mismatch between the declared HS code and the predicted HS code.
Example 30 includes the subject matter of any one of Examples 1-29, and optionally, wherein the vetting information comprises predicted tariff information corresponding to a tariff for the predicted HS code.
Example 31 includes a product comprising one or more tangible computer-readable non-transitory storage media comprising instructions operable to, when executed by at least one processor, enable the at least one processor to cause a computing system to send to a server declared goods information corresponding to goods of an imported shipment, the declared goods information comprising a declared description of the goods, and a declared Harmonic System (HS) code for the goods; process vetting information from the server to identify a predicted HS code corresponding to the declared description of the goods, and risk information to indicate one or more risks corresponding to a declaration fraud based on a mismatch between the declared HS code and the predicted HS code; and provide a Graphical User Interface (GUI) to a user, the GUI configured to present to the user the predicted HS code and the risk information.
Example 32 includes the subject matter of Example 31, and optionally, wherein the instructions, when executed, cause the computing system to process the vetting information from the server to identify tariff-mismatch information to indicate a tariff risk based on a mismatch between a first tariff for the declared HS code and a second tariff for the predicted HS code; and cause the GUI to present the second tariff for the predicted HS code and the tariff-mismatch information.
Example 33 includes the subject matter of Example 31 or 32, and optionally, wherein the instructions, when executed, cause the computing system to process the vetting information from the server to identify a predicted section code corresponding to the declared description of the goods, and section-code-mismatch information to indicate a section-code-mismatch risk based on a mismatch between a declared section code of the goods and the predicted section code; and cause the GUI to present the predicted section code and the section-code-mismatch information.
Example 34 includes the subject matter of Example 33, and optionally, wherein the predicted HS code is based on the predicted section code.
Example 35 includes the subject matter of any one of Examples 31-34, and optionally, wherein the instructions, when executed, cause the computing system to process the vetting information from the server to identify regulatory-risk information to indicate a regulatory risk based on a mismatch between first regulations for the declared HS code and second regulations for the predicted HS code; and cause the GUI to present the regulatory-risk information.
Example 36 includes the subject matter of any one of Examples 31-35, and optionally, wherein the instructions, when executed, cause the computing system to process the vetting information from the server to identify an indication that the declared description of the goods is indefinite; and cause the GUI to present the indication that the declared description of the goods is indefinite.
Example 37 includes the subject matter of any one of Examples 31-36, and optionally, wherein the declared goods information comprises a declared section code for the goods, wherein the risk information is based on the declared section code for the goods.
Example 38 includes the subject matter of any one of Examples 31-37, and optionally, wherein the declared goods information comprises tariff information corresponding to a declared tariff for the goods, wherein the risk information is based on the tariff information.
Example 39 includes the subject matter of any one of Examples 31-38, and optionally, wherein the declared goods information comprises country-of-origin information corresponding to a country of origin of the imported shipment, wherein the risk information is based on the country-of-origin information.
Example 40 includes the subject matter of any one of Examples 31-39, and optionally, wherein the instructions, when executed, cause the computing system to process first vetting information from the server to identify a first predicted HS code and first risk information corresponding to the first predicted HS code, and cause the GUI to present to the user the first predicted HS code and the first risk information corresponding to the first predicted HS code; and process second vetting information from the server to identify a second predicted HS code and second risk information corresponding to the second predicted HS code, and cause the GUI to present to the user the second predicted HS code and the second risk information corresponding to the second predicted HS code, wherein the second predicted HS code is different from the first predicted HS code, and the second risk information is different from the first risk Information.
Example 41 includes the subject matter of any one of Examples 31-40, and optionally, wherein the instructions, when executed, cause the computing system to process the vetting information from the server to identify predicted tariff information corresponding to a tariff for the predicted HS code; and cause the GUI to present the tariff for the predicted HS code.
Example 42 comprises a computing device configured to perform any of the described operations of any of Examples 1-41.
Example 43 comprises a computing system comprising one or more computing devices and/or servers configured to perform any of the described operations of any of Examples 1-41.
Example 44 comprises one or more apparatuses comprising means for executing any of the described operations of any of Examples 1-41.
Example 45 comprises a method comprising any of the described operations of any of Examples 1-41.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A product comprising one or more tangible computer-readable non-transitory storage media comprising instructions operable to, when executed by at least one processor, enable the at least one processor to cause a computing system to:
process declared goods information corresponding to goods of an imported shipment to identify a declared description of the goods and a declared Harmonic System (HS) code for the goods;
determine a predicted HS code based on the declared description of the goods;
determine risk information to indicate one or more risks corresponding to a declaration fraud based on a mismatch between the declared HS code and the predicted HS code; and
provide an output comprising vetting information, the vetting information comprising the risk information and the predicted HS code.

2. The product of claim 1, wherein the instructions, when executed, cause the computing system to:
process the declared goods information to identify a declared section code for the goods;
determine one or more potential section codes based on the declared description of the goods; and
determine the risk information based on the one or more potential section codes and the declared section code.

3. The product of claim 2, wherein the instructions, when executed, cause the computing system to:
determine a plurality of section-code scores corresponding to a plurality of predefined section codes, a section-code score corresponding to a predefined section code based on a correlation between the declared description of the goods and the predefined section code; and
select the one or more potential section codes from the plurality of predefined section codes based on the plurality of section-code scores.

4. The product of claim 3, wherein the instructions, when executed, cause the computing system to select the one or more potential section codes based on a comparison between the plurality of section-code scores and a predefined section-code threshold.

5. The product of claim 3, wherein the instructions, when executed, cause the computing system to determine the plurality of section-code scores based on a Machine Learning (ML) output of a ML engine trained to generate the ML output based on an ML input, wherein the ML input is based on the declared description of the goods.

6. The product of claim 5, wherein the ML output comprises the plurality of section-code scores corresponding to the plurality of predefined section codes.

7. The product of claim 5, wherein the instructions, when executed, cause the computing system to:
preprocess the declared description of the goods to determine a preprocessed description of the goods configured according to a predefined input format of the ML input; and
provide the preprocessed description of the goods as the ML input to the ML engine.

8. The product of claim 2, wherein the instructions, when executed, cause the computing system to:
determine one or more potential section-related HS codes based on the one or more potential section codes and the declared description of the goods; and
determine the predicted HS code based on the one or more potential section-related HS codes.

9. The product of claim 8, wherein the instructions, when executed, cause the computing system to:
determine a plurality of HS-code scores corresponding to one or more pluralities of predefined section-related HS codes, the one or more pluralities of predefined section-related HS codes corresponding to the one or more potential section codes, wherein an HS-code score corresponding to a predefined section-related HS code that corresponds to a potential section code is based on a correlation between the declared description of the goods and the predefined section-related HS code corresponding to the potential section code; and
determine the predicted HS code based on the plurality of HS-code scores.

10. The product of claim 9, wherein the instructions, when executed, cause the computing system to determine the plurality of HS-code scores corresponding to the one or more pluralities of predefined section-related HS codes based on one or more Machine Learning (ML) outputs of one or more ML engines corresponding to the one or more potential section codes, an ML engine corresponding to a potential section code trained to generate an ML output corresponding to the potential section code based on an ML input, the ML input based on the declared description of the goods.

11. The product of claim 10, wherein the ML output corresponding to the potential section code comprises a plurality of HS-code scores corresponding to a plurality of predefined section-related HS codes corresponding to the potential section code.

12. The product of claim 10, wherein the instructions, when executed, cause the computing system to select the one or more ML engines from a plurality of ML engines based on the one or more potential section codes, the plurality of ML engines corresponding to a plurality of predefined section codes.

13. The product of claim 10, wherein the instructions, when executed, cause the computing system to:
based on a determination of one or more first potential section codes, select a first set of one or more first ML engines from the plurality of ML engines and determine a first predicted HS code based on ML outputs of the one or more first ML engines; and
based on a determination of one or more second potential section codes, select a second set of one or more second ML engines from the plurality of ML engines and determine a second predicted HS code based on ML outputs of the one or more second ML engines, wherein the one or more second potential section codes are different from the one or more first potential section codes, and the first set of one or more second ML engines is different from the second set of one or more first ML engines.

14. The product of claim 2, wherein the instructions, when executed, cause the computing system to:
determine a predicted section code based on the one or more potential section codes; and
determine the risk information based on a section mismatch between the declared section code and the predicted section code.

15. The product of claim 1, wherein the instructions, when executed, cause the computing system to:
determine the risk information comprising an indication that the declared description of the goods is indefinite, based on a determination that the declared description of the goods is not specific enough to determine the predicted HS code.

16. The product of claim 1, wherein the instructions, when executed, cause the computing system to:
determine a first predicted HS code based on a first declared description of the goods; and
determine a second predicted HS code based on a second declared description of the goods, wherein the second predicted HS code is different from the first predicted HS code, and the second declared description is different from the first declared description.

17. The product of claim 1, wherein the declared goods information comprises at least one of a declared section code for the goods, tariff information corresponding to a declared tariff for the goods, or country-of-origin information corresponding to a country of origin of the imported shipment, wherein the instructions, when executed, cause the computing system to determine the risk information based on at least one of the declared section code for the goods, the tariff information, or the country-of-origin information.

18. The product of claim 1, wherein the risk information comprises tariff-mismatch information to indicate a tariff risk based on a mismatch between a first tariff for the declared HS code and a second tariff for the predicted HS code.

19. The product of claim 1, wherein the risk information comprises regulatory-risk information to indicate a regulatory risk based on a mismatch between first regulations for the declared HS code and second regulations for the predicted HS code.

20. A method comprising:
processing declared goods information corresponding to goods of an imported shipment to identify a declared description of the goods and a declared Harmonic System (HS) code for the goods;
determining a predicted HS code based on the declared description of the goods;
determining risk information to indicate one or more risks corresponding to a declaration fraud based on a mismatch between the declared HS code and the predicted HS code; and
providing an output comprising vetting information, the vetting information comprising the risk information and the predicted HS code.

21. The method of claim 20 comprising:
processing the declared goods information to identify a declared section code for the goods;
determining one or more potential section codes based on the declared description of the goods; and
determining the risk information based on the one or more potential section codes and the declared section code.
